(19) United States
(12) Patent Application Publication
(10) Pub. No.: US 2010/0013625 A1
(43) Pub. Date: Jan. 21, 2010

(54) Redundant Data Path System

(75) Inventors: Radivoj Kouzan, Flinders (AU); Glenn Gary Smith, Kemps Creek (AU); David Martin Hotson, Duffys Forest (AU)

Correspondence Address: CARSTENS & CAHOON, LLP, P O BOX 802334, DALLAS, TX, 75380, US

(73) Assignee: SURE TECHNOLOGIES PTY LTD, Wetherill Park, NSW (AU)

(21) Appl. No.: 12/307,181

(22) PCT Filed: Jul. 7, 2006
(86) PCT No.: PCT/AU06/00961

§ 371 Date: Oct. 2, 2009

(51) Int. Cl. H04B 7/02; G08B 29/00

(52) U.S. Cl. 340/508; 455/101

(57) ABSTRACT

The present invention provides a redundant data path system for transmitting an alarm signal between a monitored facility and a destination facility, said system comprising: alarm signal receiving means adapted to receive the alarm signal; destination facility identifying means adapted to identify the destination facility to which the alarm signal was directed by the monitored facility; destination facility monitoring means adapted to determine, at regular intervals, whether the destination facility is able to receive an alarm signal, either directly from the monitored facility or at all and alarm signal transmission means adapted to selectively transmit the alarm signal either to the identified destination facility, when said monitoring means indicates that the destination facility is not able to receive said alarm signal directly from the monitored facility, or to an alternate destination facility, when said monitoring means indicates that the destination facility is not able to receive said alarm signal at all.

### BACKGROUND OF THE INVENTION

1. Technical Field

The present invention relates generally to a redundant data path system. More specifically, the present invention relates to a redundant data path system for transmitting at least one alarm signal between a monitored facility and at least one destination facility. In particularly preferred embodiments, the present invention has application as a fall back system for security alarm monitoring services.

2. Background Art

A wide range of alarm monitoring systems have been available for many years. Such systems are adapted to provide notification of various events at a particular monitored facility. Typical monitored events include fire, robbery, hold-up, equipment failures, unauthorized intrusion, and other forms of undesirable incidents or tampering at or in the monitored facility. Typical alarm monitoring systems are comprised of an alarm panel located at the monitored facility and a central monitoring station adapted to receive notification from the alarm panel when a relevant undesirable occurrence is identified at the monitored facility. When an alarm signal is received at the central monitoring station, any one of a number of activities can be undertaken by central monitoring station personnel or equipment in response to the circumstance for which the alarm signal was generated. For example, personnel or equipment at the central monitoring station can notify the authorities in the event of a fire, robbery or other undesirable event requiring appropriate intervention.

There are a number of shortcomings with existing alarm monitoring systems. For instance, in the event that the central monitoring station's telephone, computer or other communication system fails, the monitored facility will cease to be monitored. Similarly, even where the communication systems of the central monitoring station are intact, but the personnel running the central monitoring station become incapacitated due to illness or injury, then the relevant action required to be taken in response to an alarm signal from the monitored facility may not be undertaken. Any such scenario, or other catastrophe, would seriously impact on the ability of the central monitoring station to provide monitoring services to any one of the number of monitored facilities which represent its clientele. A failure at any one central monitoring station could potentially leave many such customers in danger and also jeopardize any commercial operations or domestic activities (as the case may be) for such clients and the security monitoring operation itself.

Also, monitoring stations servicing large numbers of clients are required to employ significant numbers of personnel to be in a position to take appropriate action in the event of multiple alarm signals from multiple monitored facilities at any one time. The cost of employing such personnel increases considerably after normal business hours, making it difficult to balance fully servicing all of its clients' needs and running a commercially viable operation 24 hours a day (as is often required) or for extended periods. Also, smaller regional or corporate alarm monitoring stations may be capable of providing alarm monitoring services to their clients during office hours but, due to budget constraints, they may have extreme difficulty providing full service alarm monitoring after-hours.

Further, as technological advances are made to the alarm monitoring industry, various central monitoring stations may wish to offer new alarm monitoring technology to their clients. In many instances, this poses a serious commercial and practical problem as it is potentially extremely costly, both financially and in terms of downtime, to create the infrastructure to provide such new technology, including (as is often the case) the installation of new dedicated systems.

The present invention is directed towards addressing or ameliorating the above deficiencies.

In this specification, where a document, act or item of knowledge is referred to or discussed, this reference or discussion is not an admission that the document, act or item of knowledge or any combination thereof was at the priority date:
(i) part of common general knowledge; or
(ii) known to be relevant to an attempt to solve any problem with which this specification is concerned.

### SUMMARY OF THE INVENTION

In a first aspect, the present invention provides a redundant data path system for transmitting an alarm signal between a monitored facility and a destination facility, said system comprising:

alarm signal receiving means adapted to receive the alarm signal;

destination facility identifying means adapted to identify the destination facility to which the alarm signal was directed by the monitored facility;

destination facility monitoring means adapted to determine, at regular intervals, whether the destination facility is able to receive an alarm signal, either directly from the monitored facility or at all; and

alarm signal transmission means adapted to selectively transmit the alarm signal either to the identified destination facility, when said monitoring means indicates that the destination facility is not able to receive said alarm signal directly from the monitored facility, or to an alternate destination facility, when said monitoring means indicates that the destination facility is not able to receive said alarm signal at all.

Preferably, the alarm signal receiving means is a private automatic branch exchange in communication with the monitored facility.

In a preferred embodiment, the alarm signal transmitted to the destination facility identifying means comprises monitored facility-specific data including at least one monitored facility parameter.

Preferably, the destination facility identifying means includes a receiver farm, said receiver farm comprising at least one receiver means, and being adapted to generate a first identification parameter associated with the alarm signal. In a preferred embodiment, the destination facility identifying means further includes a receiver farm server, said receiver farm server comprising at least one data connection means for each receiver means in the receiver farm, with each data connection means associated with a second identification parameter for the alarm signal, the receiver farm server adapted to use the first and second identification parameters to determine the destination facility for the alarm signal.

In one preferred embodiment, the monitored facility parameter comprises caller line identification data generated by the alarm signal receiving means. Preferably, the monitored facility-specific data is a pseudo extension number related to the caller line identification data—in another preferred embodiment, the monitored facility parameter comprises a dialed telephone number dialed by the monitored facility to convey the alarm signal. Preferably, the monitored facility-specific data is a pseudo extension number related to the dialed number dialed by the monitored facility.

The first identification parameter is preferably a physical receiver number. The second identification parameter is preferably a number designated to the data connection means which receives the alarm signal.

Preferably, the determination of the destination facility includes inputting the first and second identification parameters into a first database containing a plurality of parameters associating each monitored facility with at least one destination facility. In one embodiment, the determination of the destination facility further includes determining a destination bureau identification by reference to the first identification parameter and the second identification parameter.

Preferably, the plurality of parameters associating each monitored facility with at least one destination facility includes the first identification parameter, the second identification parameter, a destination virtual receiver number, the destination bureau identification, and a destination line number.

In one preferred embodiment, the redundant data path system is adapted to operate whether or not the alarm signal can be transmitted to the destination facility via. a preexisting data path system.

Preferably, the destination facility monitoring means includes polling message means adapted to send a poll message to at least a primary address for the destination facility, and to monitor whether a response is received from the primary address, and designate a lack of response within a specified period as OFFLINE. In one embodiment, the poll message is further sent to at least a secondary address for the destination facility, and the polling message means further monitor whether a response is received from the secondary address, and designates a lack of response within a specified period as OFFLINE.

If the primary address and secondary address are both designated as OFFLINE, but were previously both designated as ONLINE, a notification is preferably sent to a data centre informing that communication between the routing means and destination facility has been lost. In such a circumstance, the data centre may assume the monitoring functions of the destination facility.

If the primary address and secondary address are both designated as ONLINE, but were previously both designated as OFFLINE, a notification is preferably sent to a data centre informing that communication between the routing means and destination facility has been restored.

Preferably, the primary and secondary addresses are internet protocol addresses.

The alarm signal transmission means of preferred embodiments includes routing means adapted to transmit the alarm signal between the receiver farm server and the destination facility. Preferably, the routing means comprises a routing means server and a routing means receiver, said routing means server being adapted to communicate with the routing means receiver to transmit the alarm signal to the destination facility.

Preferably, transmission of the alarm signal between the receiver farm server and the destination facility includes manipulation of data associated with the alarm signal such that the data received by the destination facility appears substantially identical to that which would have been received by the destination facility if the alarm signal had been transmitted by the pre-existing data path system.

In a preferred embodiment, the routing means server communicates with the routing means receiver by one or more routing data path systems selected from the group consisting of asymmetric digital subscriber line means, satellite communication means, general packet radio service means, fixed line transmission means, wireless transmission means, and a data centre adapted to selectively transmit data from the routing means server to the routing means receiver or monitor transmission of the alarm signal without further transmitting the alarm signal to the destination facility. Preferably, the routing data path system is selected according to the availability or operability of each alternative routing data path system.

In one preferred embodiment; the data centre adopts the monitoring functions of one. or more destination facilities when each of the alternative routing data path systems are disconnected or inoperable.

In another preferred embodiment, the destination facility selectively delegates its monitoring functions to the data centre by temporarily disconnecting each alternative routing data path system and each pre-existing data path system.

In a second aspect, the present invention provides a redundant data path system for transmitting at least one alarm signal between a monitored facility and at least one destination facility, said system comprising;

alarm signal receiving means adapted to receive the alarm signal,

a receiver farm comprising at least one receiver means, and being adapted to generate a first identification parameter associated with the alarm signal,

a receiver farm server comprising at least one data connection means for each receiver means in the receiver farm, with each data connection means associated with a second identification parameter for the alarm signal, the receiver farm server adapted to use the first and second identification parameters to determine the destination facility for the alarm signal, and

routing means adapted to transmit the alarm signal between the receiver farm server and the destination facility.

Preferably, the alarm signal receiving means is a private automatic branch exchange in communication with the monitored facility.

Preferably, the alarm signal transmitted to the receiver farm comprises monitored facility-specific data including at least one monitored facility parameter,

In one preferred embodiment the monitored facility parameter comprises caller line identification data generated by the alarm signal receiving means. Preferably, the monitored facility-specific data is a pseudo extension number related to the caller line identification data.

In another preferred embodiment, the monitored facility parameter comprises a dialed telephone number dialed by the monitored facility to convey the alarm signal. Preferably, the monitored facility-specific data is a pseudo extension number related to the dialed number dialed by the monitored facility.

Preferably, the first identification parameter is a physical receiver number and the second identification parameter is a number designated to the data connection means which receives the alarm signal.

Preferably, the determination of the destination facility includes inputting the first and second identification parameters into a first database containing a plurality of parameters associating each monitored facility with at least one destination facility. In one preferred embodiment, the determination of the destination facility further includes determining a destination bureau identification by reference to the first identification parameter and the second identification parameter.

The plurality of parameters associating each monitored facility with at least one destination facility preferably includes the first identification parameter, the second identification parameter, a destination virtual receiver number, the destination bureau identification, and a destination line number.

In a preferred embodiment, the redundant data path system is adapted to operate whether or not the alarm signal can be transmitted to the destination facility via a pre-existing data path system.

Preferably, transmission of the alarm signal between the receiver farm server and the destination facility includes manipulation of data associated with the alarm signal such that the data received by the destination facility appears substantially identical to that which would have been received by the destination facility if the alarm, signal had been transmitted by the pre-existing data path system.

In a preferred embodiment, the routing means comprises a routing means server and a routing means receiver, said routing means server being adapted to communicate with the routing means receiver to transmit the alarm signal to the destination facility,

Preferably, the routing means server communicates with the routing means receiver by one or more routing data path systems selected from the group consisting of asymmetric digital subscriber line means, satellite communication means, general packet radio service means, fixed fine transmission means, wireless transmission means, and a data centre adapted to selectively transmit data from the routing means server to the routing means receiver or monitor transmission of the alarm signal without further transmitting the alarm signal to the destination facility. Preferably, the routing data path system is selected according to the availability or operability of each alternative routing data path system.

In some such embodiments, the data centre adopts the monitoring functions of one or more destination facilities when each of the alternative routing data path systems are disconnected or inoperable.

In one preferred embodiment, the destination facility selectively delegates its monitoring functions to the data centre by temporarily disconnecting each alternative routing data path system and each pre-existing data path system.

Preferably, the routing means include connection monitoring means for monitoring communication between the routing means and the destination facility, the connection monitoring means comprising polling message means adapted to send a poll message to at least a primary address for the destination facility, and to monitor whether a response is received from the primary address, and designate a lack of response within a specified period as OFFLINE.

In some preferred embodiments, the poll message is further sent to at least a secondary address for the destination facility, and the polling message means further monitor whether a response is received from the secondary address, and designates a lack of response within a specified period as OFFLINE.

If the primary address and secondary address are both designated as OFFLINE, but were previously both designated as ONLINE, a notification is preferably sent to a data centre informing that communication between the routing means and destination facility has been lost. In some such embodiments, the data centre assumes the monitoring functions of the destination facility.

If the primary address and secondary address are both designated as ONLINE, but were previously both designated as OFFLINE, a notification is preferably sent to a data centre informing that communication between the routing means and destination facility has been restored.

Preferably, the primary and secondary addresses are internet protocol addresses.

In one preferred embodiment of the data path of the second aspect, the routing means server includes a second database containing a plurality of parameters relating to communication between the routing means and the destination facility, Preferably, the plurality of parameters includes at least one configuration parameter, at least one out-queue parameter and at least one in-queue parameter.

Preferably, the at least one configuration parameter is selected from the group consisting of the destination bureau identification, the primary address for the destination facility, the secondary address for the destination facility, and the status of each connection with the primary address and the secondary address.

Preferably, the at least one out-queue parameter is selected from the group consisting of the destination bureau identification, event time data, alarm message data, retry count data, sent time data, and acknowledgement time data.

Preferably, the at least one in-queue parameter is selected from the group consisting of data adapted to be processed by the data centre and data communicated by the routing means receiver to the routing means server.

In a preferred embodiment of the invention of the second aspect, the routing means server further includes at least one communication driver means adapted to deliver data associated with the alarm signal to the destination facility and to receive incoming data from the routing means server. Preferably, one communication driver means is dedicated to each destination facility.

Preferably, the communication driver means is adapted to enter a send mode when the second database contains an alarm signal for the destination facility to which the communication driver means is dedicated. In one preferred embodiment, in send mode, one or more of the following send-mode steps occur:

if the primary address for the destination facility is designated ONLINE by the connection monitoring means, the alarm signal is sent to the primary address,

if the primary address is designated OFFLINE by the connection monitoring means, and the secondary address for the destination facility is designated ONLINE, the alarm signal is sent to the secondary address,

if the primary address and the secondary address are both designated OFFLINE by the connection monitoring means, the communication driver means makes a second attempt to send the alarm signal to the primary address, and

if no response is received within a first predetermined period, the alarm signal is re-sent and a retry counter means increments the retry count data, and

if no response is received within a second predetermined period, communication between the routing means server and the primary address of the destination facility is designated OFFLINE, and a notification is sent to a data centre informing that communication between the routing means and destination facility is lost, or

if the alarm signal has been successfully received by the destination facility, the acknowledgement time data is update in the second database.

Preferably, one or more of the send-mode steps are repeated for each alarm signal in the second database.

In another preferred embodiment, the routing means further include an error handling means for informing a data centre of communications between the routing means and the destination facility. Preferably, the error handling means notifies the data centre when:

designation of a connection between the routing means and the destination facility changes from ONLINE to OFFLINE,

designation of a connection between the routing means and the destination facility changes from OFFLINE to ONLINE,

one or more alarm signals have remained in the routing means server for in excess of a predetermined period,

a predetermined re-try count threshold has been exceeded,

a restore time limit has been exceeded,

a restore retry limit has been exceeded, or

one or more system errors occur.

Preferably, a system error is selected from the group consisting of a database error and a database connection lost.

In another preferred embodiment, the routing means server further includes data handling means adapted to collect and queue data on behalf of a data centre, and to manage and process the in-queue parameters for the routing means server. Preferably, the data collected and queued on behalf of the data centre is selected from the group consisting of messages initiated by the data centre and data associated with the destination facility.

Throughout this specification, unless the context requires otherwise, the word “comprise¹¹, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this specification.

In order that the present invention may be more clearly understood, preferred embodiments will be described with reference to the following drawings and examples.

### BRIEF DESCRIPTION OF THE DRAWINGS

The invention will now be further explained and illustrated by reference to the accompanying drawings in which:

FIG. 1 is a schematic representation of a co-location facility using a redundant data path system of a preferred embodiment of the invention.

FIG. 2 is a flow diagram illustrating the flow of data through a redundant data path system of the invention with detailed reference to a preferred embodiment of the receiver farm server.

FIG. 3 is a illustration of the information contained in a preferred embodiment of a receiver farm server database of the present invention.

FIG. 4 is a flow diagram illustrating the operation of a preferred embodiment of the receiver farm server's receiver handler.

FIG. 5 is a table illustrating an example of the information contained in a packet format of a preferred embodiment of the present invention.

FIG. 6 is a table illustrating an example of the information contained in a heartbeat packet format of a preferred embodiment of the present invention.

FIG. 7 is a table illustrating an example of the information contained in a caller ID packet format of a preferred embodiment of the present invention.

FIG. 8 is a flow diagram illustrating the operation flow of events of a preferred embodiment of the invention during the processing of received serial data from an alarm receiver.

FIG. 9 is a flow diagram illustrating an overview of the interaction between a preferred embodiment of the routing means server and routing means receiver of the present invention.

FIG. 10 is a schematic representation of a preferred embodiment of a routing means receiver of the present invention.

FIG. 11 is a flow diagram illustrating the flow of data during primary module start-up in a routing means receiver of a preferred embodiment of the present invention.

FIG. 12 is a flow diagram illustrating the flow of data during primary module initialization of the serial thread in a routing means receiver of a preferred embodiment of the present invention.

FIG. 13 is a flow diagram illustrating the flow of data during primary module initialization of the user datagram protocol (UDP) thread in a routing means receiver of a preferred embodiment of the present invention.

FIG. 14 is a flow diagram illustrating the operation flow of data by the primary module serial data handler of a routing means receiver of a preferred embodiment of the present invention.

FIG. 15 is a flow diagram illustrating the operation flow of data by the primary module user datagram protocol (UDP) data handler of a routing means receiver of a preferred embodiment of the present invention.

FIG. 16 is a flow diagram illustrating the flow of data during processing of the serial packet by the primary module of a routing means receiver of a preferred embodiment of the present invention.

FIG. 17 is a flow diagram illustrating the flow of data during processing of a user datagram protocol (UDP) packet by the primary module of a routing means receiver of a preferred embodiment of the present invention.

FIG. 18 is a flow diagram illustrating the flow of data during the primary module send to UDP phase of a routing means receiver of a preferred embodiment of the present invention.

FIG. 19 is a flow diagram illustrating the flow of data during the primary module send to serial phase of a routing means receiver of a preferred embodiment of the present invention.

FIG. 20 is a flow diagram illustrating the flow of data as the system monitor performs a continuous check of the UDP and serial activity in a routing means receiver of a preferred embodiment of the present invention.

FIG. 21 is a schematic representation illustrating a preferred wiring arrangement of the relay operation allowing the primary module and secondary module to co-exist in a preferred embodiment of the invention.

FIG. 22 is a schematic representation illustrating the routing means server modules, of a preferred embodiment of the invention.

FIG. 23 is a illustration of the information contained of a routing means server database of a preferred embodiment of the present invention.

FIG. 24 is a flow diagram illustrating the operation flow of data in the routing means server's ADSL handler of a preferred embodiment of the present invention.

FIG. 25 is a flow diagram illustrating the operation flow of data in the routing means server's poll primary connection function of a preferred embodiment of the present invention.

FIG. 26 is a flow diagram illustrating the operation flow of data during OutQueue handling in a routing means server of a preferred embodiment of the present invention.

FIG. 27 is a flow diagram illustrating the flow of data during the send heartbeat phase in a routing means server of a preferred embodiment of the present invention.

FIG. 28 is a flow diagram illustrating the operation flow of data during the send message queue phase in a routing means server of a preferred embodiment of the present invention.

FIG. 29 is a flow diagram illustrating the flow of data upon receipt from the UDP port in a routing means server of a preferred embodiment of the present invention.

FIG. 30 is a flow diagram illustrating the operation flow of data during the processing of the serial data packet in a routing means server of a preferred embodiment of the present invention.

FIG. 31 is a flow diagram illustrating the operation flow of data during the processing of the serial acknowledgement (ACK)/negative acknowledgement (NAK) packet in a routing means server of a preferred embodiment of the present invention.

FIG. 32 is a flow diagram illustrating the operation flow of data in the routing means server's GPRS handler of a preferred embodiment of the present invention.

FIG. 33 is a flow diagram illustrating the operation flow of data in the routing means server's poll secondary connection function of a preferred embodiment of the present invention.

FIG. 34 is a flow diagram illustrating the operation flow of data during OutQueue handling in a routing means server of a preferred embodiment of the present invention.

FIG. 35 is a flow diagram illustrating the flow of data during the send heartbeat phase in a routing means server of a preferred, embodiment of the present invention.

FIG. 36 is a flow diagram illustrating the operation flow of data during the send message queue phase in a routing means server of a preferred embodiment of the present invention.

FIG. 37 is a flow diagram illustrating the flow of data upon receipt from the UDP port in a routing means server of a preferred embodiment of the present invention.

FIG. 38 is a flow diagram illustrating the operation flow of data during the processing of the serial data packet in a routing means server of a preferred embodiment of the present invention.

FIG. 39 is a flow diagram illustrating the operation flow of data during the processing of the serial acknowledgement (ACK)/negative acknowledgement (NAK) packet in a routing means server of a preferred embodiment of the present invention.

FIG. 40 is a flow diagram illustrating the operation flow of data in the routing means server's data handler of a preferred embodiment of the present invention.

FIG. 41 is a flow diagram illustrating the operation flow of data in the routing means server's error/exception handler of a preferred embodiment of the present invention.

FIG. 42 is a flow diagram illustrating the operation flow of data during an out queue exception handling phase in a routing means server of a preferred embodiment of the present invention.

FIG. 43 is a flow diagram illustrating the operation flow of data during a connection status check in the routing means server of a preferred embodiment of the present invention.

FIG. 44 is a flow diagram illustrating the operation flow of data during further aspects of the connection status-check illustrated in FIG. 43 in the routing means server of a preferred embodiment of the present invention.

FIG. 45 is a flow diagram illustrating the operation flow of data during out queue exception handling phase in a routing means server of a preferred embodiment of the present invention.

FIG. 46 is a flow diagram illustrating the operation flow of data in the routing means server's serial handler of a preferred embodiment of the present invention.

FIG. 47 is a flow diagram illustrating the flow of data during the process serial message queue phase in the serial handler in a routing means server of a preferred embodiment of the present invention.

FIG. 48 is a flow diagram illustrating the operation flow of data in the routing means server's send serial data function of a preferred embodiment of the present invention.

FIG. 49 is a flow diagram illustrating the operation flow of data in the routing means server's handle serial input function of a preferred embodiment of the present invention.

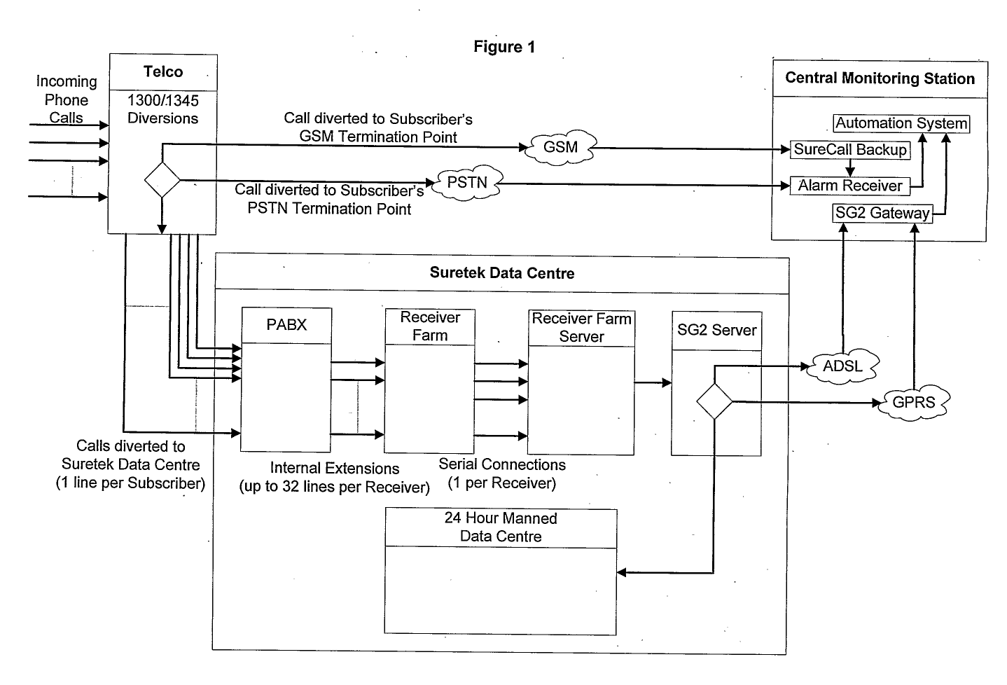

### DETAILED DESCRIPTION OF PREFERRED EMBODIMENTS

Preferred embodiments of the present invention are described in the discussion below.

### 1. Abbreviations and Definitions

Unless otherwise specified, the following abbreviations are applicable to the text which follows:
   ADSL Asymmetric Digital Subscriber Line (Broadband Internet Service)
   CLF Co-Location Facility
   CLI Calling Line Identification (Phone number of the caller)
   CMS Central Monitoring Station
   DNIS Dialed Number Identification Service (Phone number that the caller dialed)
   GPRS General Packet Radio Service
   RFS Receiver Farm Server
   SDC Data Centre
   VPN Virtual Private Network
   RSU Remote Software Upgrade
   UDP User Datagram Protocol
   FTP File Transfer Protocol
   ED Light Emitting Diode
   SLIP Serial Line Internet Protocol
   GUI Graphical User Interface
   LAN Local Area Network
   (P Internet Protocol
   ACK Acknowledgement
   NAK Negative Acknowledgement
   Any reference in the following description to the terms listed below have the following meanings:
   “SureCall™ GSM Backup Unit” means an automated GSM diversion system providing wireless redundancy for the CMS.
   “Suretek™ diversion” means a redundant data path system of a preferred embodiment of the present invention.
   “Suretek™ SG2™ receiver” means a routing means receiver of a preferred embodiment of the present invention.

### 2. Co-Location Facility Overview

2.1. Telecommunications Service Provider
The first stage in a co-location facility (CLF) is the telecommunications service provider. Each incoming 1300 or 1345 telephone number (or similar such telephone number in jurisdictions within or outside Australia) is mapped to a series of terminating points. The arrangement of these terminating points determines what type of CLF 5 solution is in place for the central monitoring station (CMS). Some preferred scenarios are listed below:
   1. Public switched telephone network (PSTN) diversion only (of 1345xxχx redirected to 02xxxxxxxx).
      This solution requires the CMS to have:
         A dialer alarm receiver, and
         Incoming PSTN lines.
   2. PSTN diversion, plus a global system for mobile communication (GSM) diversion upon busy or no answer (i.e. 1345xxxx redirected to 02xxxxxxxχ, but if busy or no answer then redirected to 04xxxxxxxx).
      This solution requires the CMS to have:
         A dialer alarm receiver (plus, possibly, extra line cards),
         Incoming PSTN lines,
         SureCall™ GSM Backup unit (with SIM cards).
   3. PSTN diversion, plus GSM diversion, plus Suretek™ diversion (i.e. 1345χxxx redirected to 02xχχxxxxxᵣ but if busy or no answer then redirected to 04xxxχxxxxₚ and if GSM is busy or no answer then redirect to 02Suretek (i.e. routed via Suretek™ diversion).
      This solution requires the CMS to have:
         A dialer alarm receiver (plus, possibly, extra line cards),
         Incoming PSTN lines,
         SureCall™ GSM Backup unit (with SIM cards), and
         Suretek™ SG2™ receiver.
   4. PSTN diversion, plus Suretek™ diversion (i.e. 1345xxxx redirected to 02xxχxxxxx, but if busy or no answer then redirected to 02Suretek (i.e. routed via Suretek™ diversion).
      This solution requires the CMS to have:
         A dialer alarm receiver,
         incoming PSTN lines, and
         Suretek™ SG2™ receiver.
   5. Suretek diversion only (i.e. 1345xxxx redirected to 02Suretek (i.e. routed via Suretek™ diversion).
      This solution requires the CMS to have:
         Suretek™ SG2™ receiver.

2.2. SureCall™ GSM Backup Unit
The SureCall™ GSM Backup Unit receives incoming GSM phone calls from the alarm panels and outputs the data across a normal telephone cable to a dialer alarm receiver. As far as the dialer alarm receiver is concerned, the incoming telephone lines (direct PSTN and SureCall™ output) appear exactly the same.

2.3. Redundant Data Path System of One Preferred Embodiment
The redundant data path system of one preferred embodiment contains the following systems for the CLF:
   Private Automatic Branch Exchange (PABX)
   Receiver Farm
   Receiver Farm Server
   Routing means
In preferred embodiments, the routing means includes a routing means server and a routing means receiver. The routing means receiver and its interaction with the routing means server is discussed in more detail below.

2.3.1. PABX
The alarm panel in the field dials a 1345xxxx number that belongs to the CMS. The telecommunications service provider redirects this call to the redundant data path system terminating number that is dedicated to that CMS (after a decision is made based upon the CLF strategies described above). Based upon the line upon which the call was received, the PABX presents the call to the Receiver Farm with a pseudo extension number.
The alarm events can be received by connecting the outside phone lines directly to the alarm receivers, but this would provide the calling number of the panel that is making the call. To implement a solution using the Caller ID of each alarm panel may be difficult to manage. For instance, some phone numbers are blocked (or suppressed), and, the CLF would need to be aware of every alarm panel that could be transmitting an alarm event via this system. This number would be in the 1000's and constantly changing.
Alternatively, connecting the outside phone lines directly into the alarm receiver and relying on the line number to uniquely identify the CMS to which the monitored site belongs would also work, but may be a costly exercise, Some subscribers may only have a few monitored sites, but still require a dedicated line which does not make efficient use of the alarm receivers.
This is where the PABX provides input into a preferred embodiment of the system of the present invention.
This solution does not require the phone number of the calling alarm panel, but the phone number that the alarm panel called. This ‘service¹ is achieved by dedicating each line of the PABX to receiving calls on only one phone number. The configuration of the PABX is such that the phone number that is presented to the Receiver Farm is an internally generated extension number, allowing the Receiver Farm to uniquely identify to which CMS the monitored site (i.e. dialing alarm panel) belongs.
In contrast to the two optional scenarios described above, this solution makes efficient use of the alarm receivers, The number of alarm receivers is proportional to the volumes of calls that are made to the system by the monitored sites of all subscribers to this service, rather than being proportional to the number of subscribers to the service.

2.3.2. Receiver Farm
The Receiver farm is a bank of alarm receivers that are capable of recognizing Calling Line Identification (CU). The phone call that is presented to the alarm receivers has a unique extension number that is used to identify to which CMS the dialing panel (i.e. monitored site) belongs. The Receiver Farm sends a message to the Receiver Farm Server via a serial connection that contains the CLI (PABX generated extension number), followed by the alarm event data.

2.3.3. Receiver Farm Server
The Receiver Farm Server (RFS) is connected to the Receiver Farm via a set of RS232 serial cables. There is one serial connection for each physical receiver in the farm.
The RFS contains a lookup table that comprises the following fields:
   Phone Number (or extension number)
   Destination Receiver Number
   Destination Line No
   Destination Bureau ID
The RFS extracts the Phone Number from the received data packet to determine the Destination Virtual Receiver Number, the Destination Line Number and the Destination Bureau ID.
The RFS modifies the data packet by replacing the Virtual Receiver Number with the Destination Receiver Number and similarly for the Line Number, This manipulation is performed so that the data received by the CMS appears exactly as it would if delivered directly rather than via the CLF.
The RFS then passes this alarm data to the SG2™ Server where it is queued to be delivered to the appropriate Bureau (or subscriber to this service).

2.3.4. Routing Means Server (Sometimes Referred to as SG2™ Server in the Specification and Figures)
The routing means server functions in conjunction with the routing means receiver (sometimes referred to as SG2™ Gateway in the specification and figures) to deliver alarm data to the CMS. For redundancy purposes the routing means server sends data via several paths, including:
   Asymmetric Digital Subscriber Line (ADSL)
   Satellite
   General Packet Radio Service (GPRS)
   24/7 manned data centre (located, in one embodiment, at Data Centre premises).
The SG2™ Gateway receives data via one of two paths:
   ADSL
   GPRS
In the case where the CMS experiences a loss of incoming telephone lines, then the ADSL connection to the SG2™ Receiver will probably also be lost. The GPRS connection caters for the situation where the CMS is still operational, but not able to receive data via conventional means.
In the case where the CMS cannot operate (E.g. Destroyed), the alarm data can be processed loyally by the 24/7 Data Centre. At such time when the CMS is recovered, the queued data during the down period is transmitted.
Specific details of the operation of the SG2™ Server and SG2™ Gateway, are provided in other sections of this document.

### 3. Receiver Farm Server

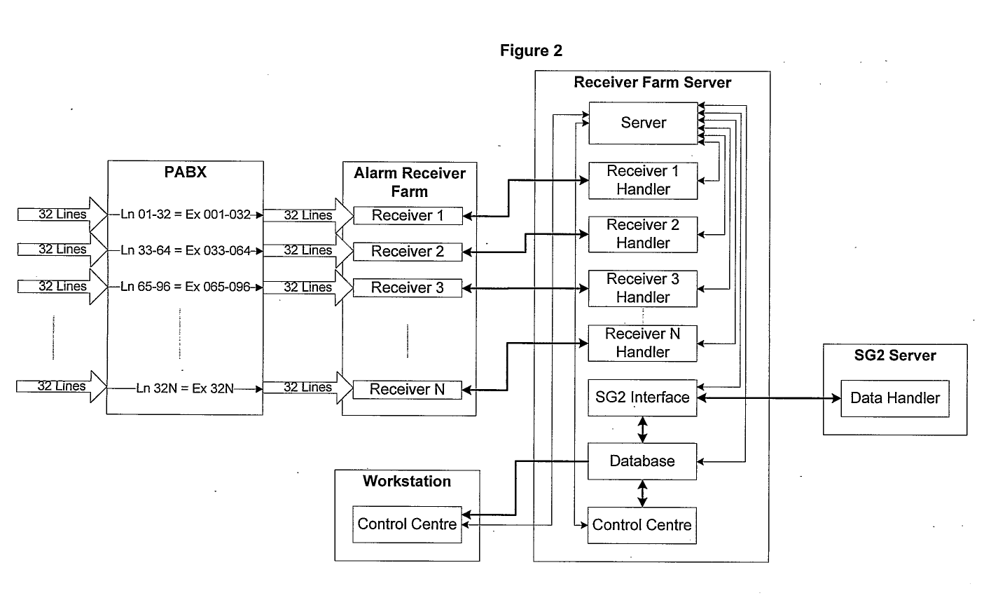

3.1. Overview
The diagram in FIG. 2 shows the operation of the CLF with respect to the Receiver Farm Server (RFS).
The incoming alarm phone calls are received by the PABX and (by way of configuration) are presented to the alarm receivers (in the Receiver Farm) with an extension number. The alarm receiver that receives the call sends a message that contains the extension number (i.e. caller id generated by the PABX) to the corresponding RFS's Receiver Handler (via a serial connection), followed by on© or more messages that contain the alarm event information. The Receiver Handler uses the Caller ID information to identify the Bureau to which the alarm event belongs and sends this information to the SG2™ Server for delivery to the Bureau's CMS.
The RFS is comprised of a several modules that perform their individual tasks centered around the database. These include the following:
   Server
   Receiver Handler
   SG2™ Interface
   Control Centre, and
   Database.
The Server module is responsible for spawning and monitoring the status of each of the other modules (including an instance of the Receiver Handler for each Alarm
Receiver and the 862™ Interface). The operation that is performed by each of these modules is detailed later in this specification.
The Server Module also checks the database connectivity and the status of each of the serial connections to the Receiver Handlers. The Server Module also acts as a message agent Each module posts their activity to the Server module and the Server module relays these messages to all connected Control Centre clients. The Control Centre client is a GUI, which can run on any workstation on the LAN, and is used for system configuration and activity monitoring.

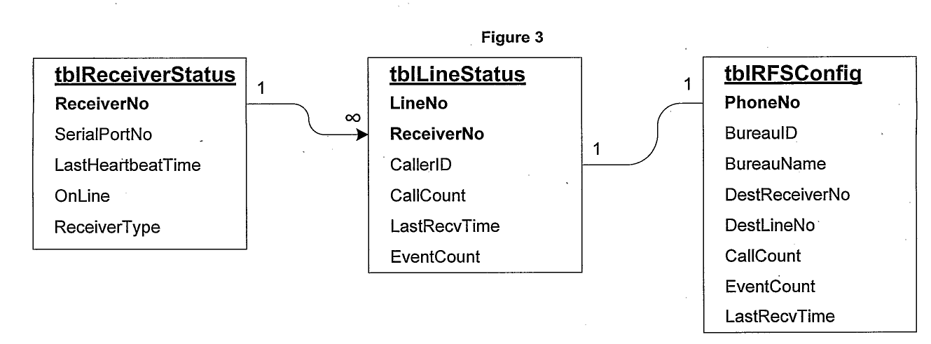

3.2. Database
The RFS Database schema is detailed in FIG. 3.
The table tblReceiverStatus contains one record for each Receiver Handler in the system with information that pertains to its connectivity to a Receiver in the Receiver Farm. The ReceiverType field is used by the Receiver Handler to know to what type of receiver it is connected; and hence know how to interface to it. This table is also used by the server to determine the online status of each receiver based upon the LastHeartbeatTime field.
The table tbLineStatus contains one record per line per receiver and is primarily used to keep track of the current caller id information on each line of each receiver. For example, if each receiver in the farm was capable of handling 32 lines, then 10 receivers would constitute 320 records in this table.
The table tblRFSConfig is used to identify the Bureau to which the alarm event is to be reported and how the message should be constructed (i.e. Destination Receiver Number and Destination Line Number).

3.3. Server Module
The RFS Server Module spawns an instance of a Receiver Handler based upon the settings in the tblReceiverStatus table of the database. It also monitors this table for changes so that additional receivers can be added or existing receivers can be removed dynamically.
The RFS Server also monitors the LastHeartbeatTime for each receiver connection and generates an alert if communications are lost or restored.

3.4. SG2™ Interface
The RFS has an interface to the SG2™ Server for the- purpose of requesting messages to be delivered to their appropriate destination (based upon the Bureau to which they have been identified as belonging). This interface is also used for relaying RFS system alerts (such as “RFS Receiver No 1 OFFLINE”, etc) to a Data Centre [SDC) Automation System.
This interface can be implemented in various ways, including, for example:
Transaction File Method—each alarm event is written to a disk file in a location defined by—the SG2™ Server. These files contain enough information for the SG2™ Server's Data Handler to process (i.e. send to SDC Automation System, Send to a destination Bureau via the SG2™ Gateway, etc). The advantage of this method is that the RFS does not need to be aware of the SG2™ Server as it is the responsibility of the SG2™ Server to collect and process these transaction files.
Direct Database Manipulation—the RFS needs to have a connection to the SG2™ Database and have access to the tblOutQueue and tblSerialQueue. Messages that are to be delivered to a destination Bureau via the SG2™ Gateway are appended to the tblOutQueue table, while messages that are to be delivered to the SDC Automation System are appended to the tblSerialQueue table. One advantage of this system is that there is no additional delay since the event messages are immediately queued. However, it requires a fallback store for messages in the case where the SG2™ Database is temporarily unavailable and an alternative method of alerting personnel of system trouble.
Bi-directional Serial Interface—the RFS needs to have a module similar to the SG2™ Server's Serial Handier (connection to the SDC Automation System) and the SG2™ Server needs a corresponding module through which to communicate. One advantage of this method is that the SG2™ Server can monitor the status of the serial connection and report exceptions to the SDC Automation System quite easily. However, the RFS will be receiving data from many serial ports and directing all of these through a single port to the SG2™ Server. This could create temporary delays during periods of high activity, so a queuing method needs to be in place (i.e. a Serial Queue as in the SG2™ Server's Database).
Irrespective of which method is employed, the purpose of the SG2™ Interface is to relay alerts and message requests to the SG2™ Server for processing. The invention contemplates any method that would be capable of achieving this objective.

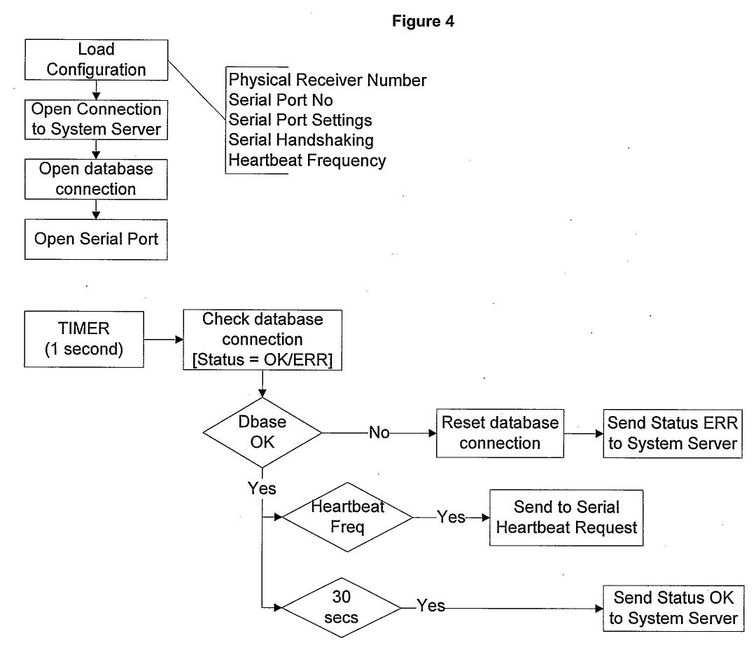

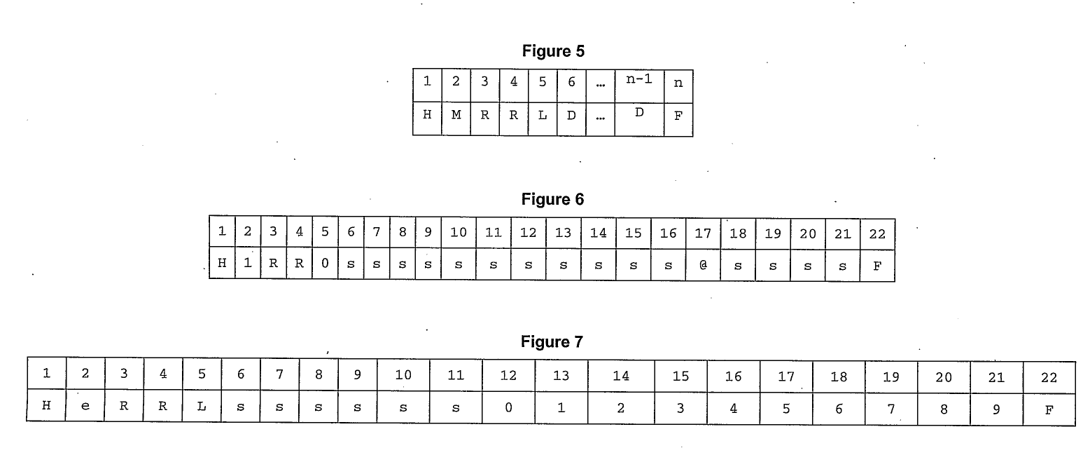

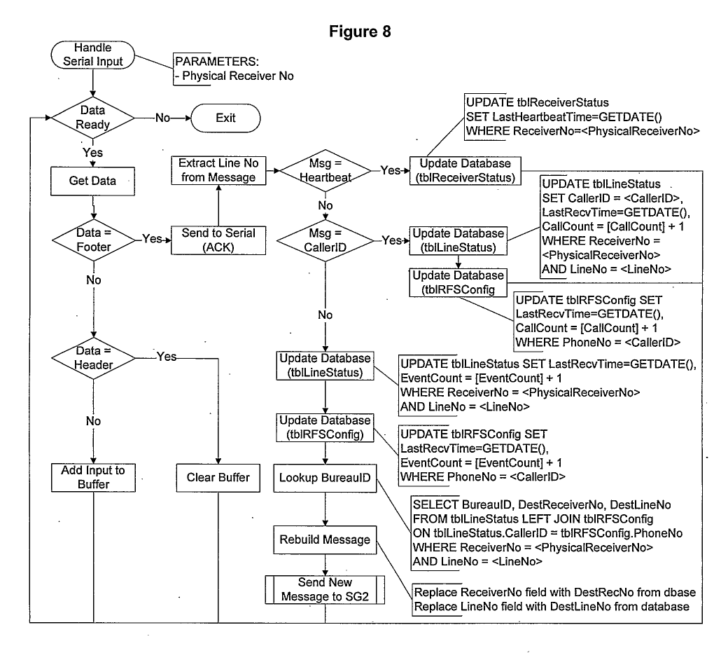

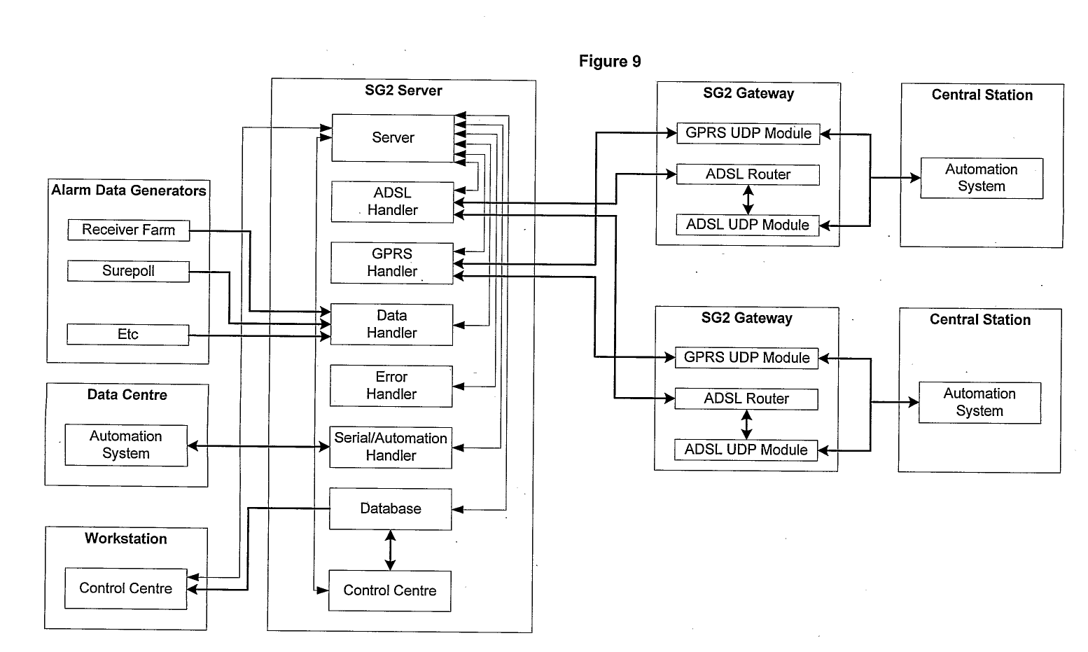

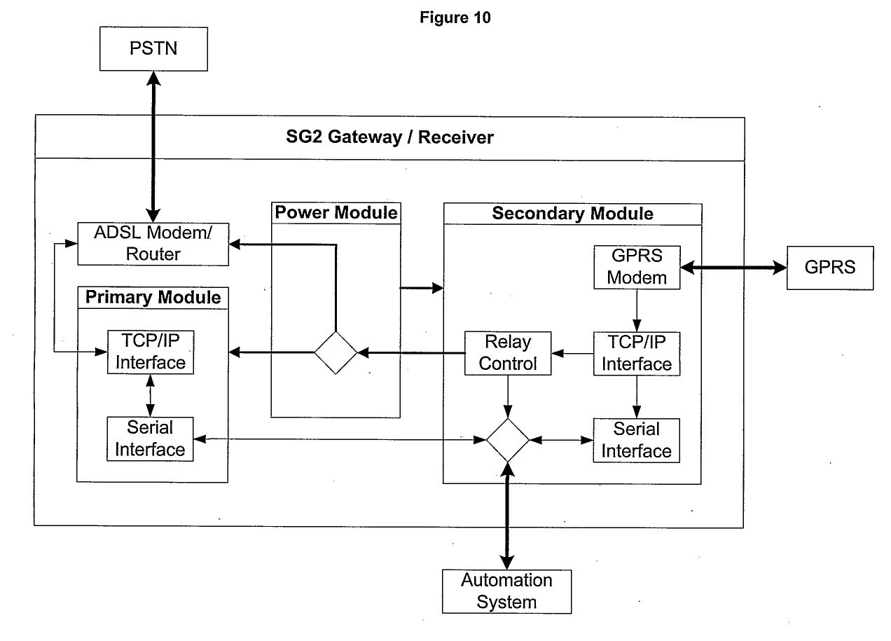

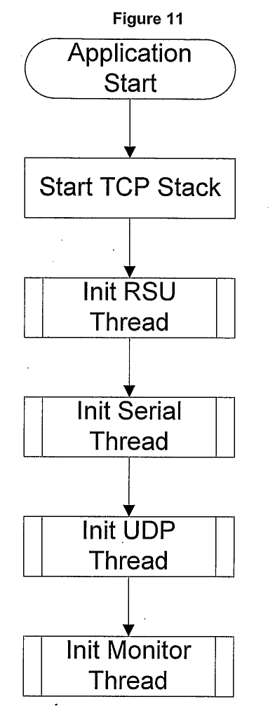

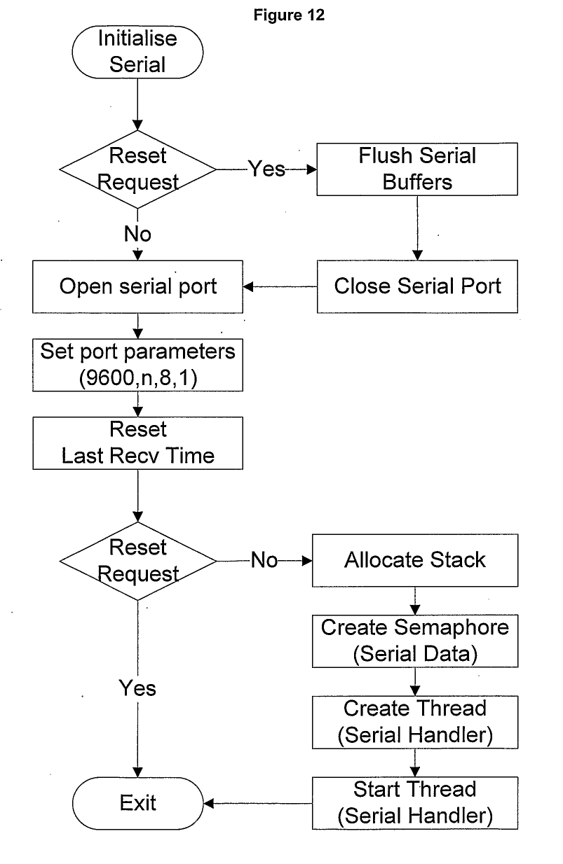

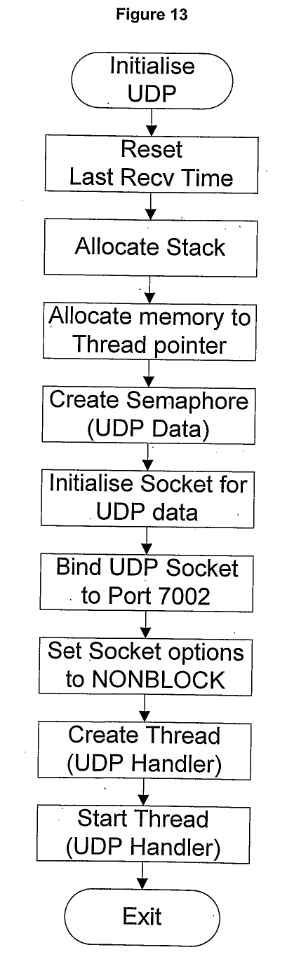

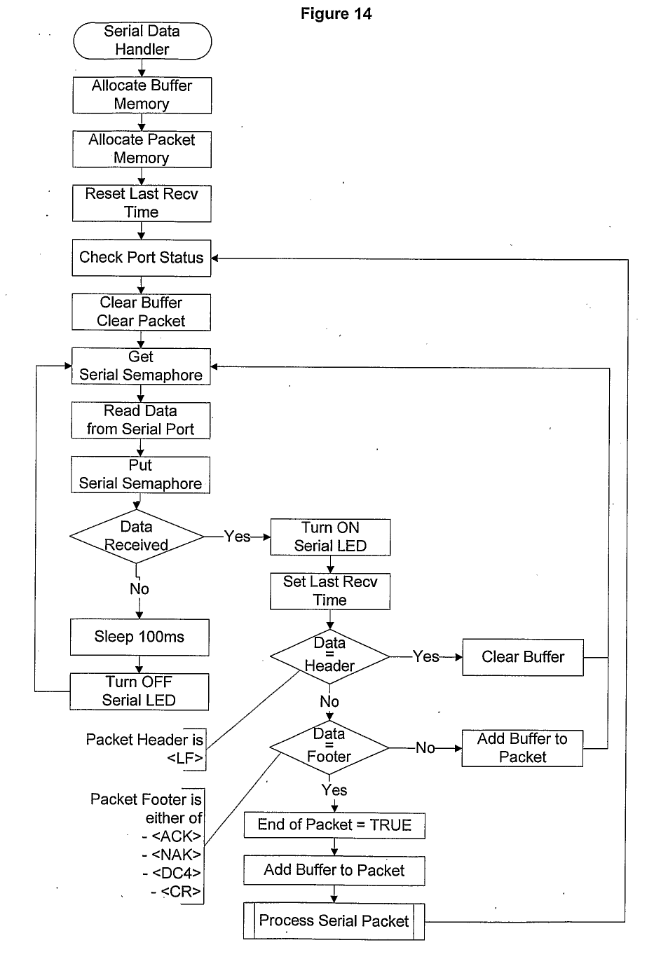

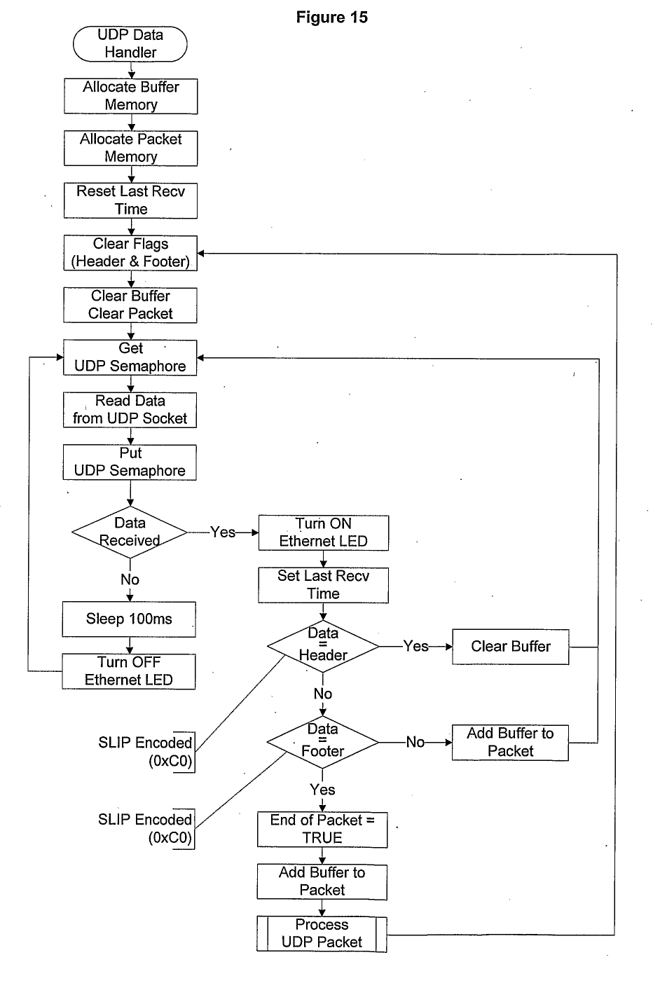

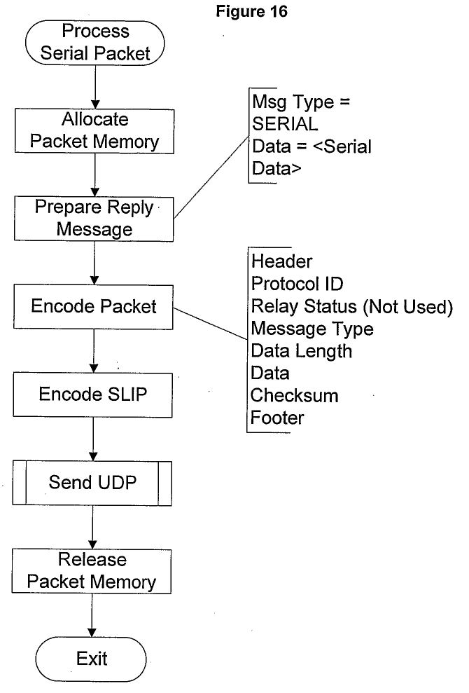

3.5. Receiver Handler
3.5.1. Startup and Timer Operation
   The Primary Receiver Handler is responsible for the following tasks:
      Monitoring the connection status of the alarm receiver to which it is directly connected,
      Sending periodic heartbeat requests, and
      Receiving caller id and event data from the alarm receiver.
   The parameters used by the Receiver Handler module include:
      Physical Receiver Number (one Receiver Handler is required per Alarm Receiver)
      Serial Port Number
      Serial Port Settings (i.e., Baud rate, etc)
      Serial Port Handshaking (i.e. Hardware flow control, etc)
      Heartbeat Frequency (rate at which the heartbeat message is requested from the alarm receiver)
   Upon startup, the Receiver handler Module loads the above configuration parameters, opens a connection back to the RFS Server Module (for the purpose of reporting activity as well as any error conditions), opens a connection to the RFS Database and Initializes the Serial Port for receiving data, and starts a 1 second timer that triggers the above mentioned tasks. The diagram in FIG. 4 illustrates the operation of the RFS's Receiver Handler,
3.5.2. Serial Input Handler
   This function is triggered whenever data is ready to be collected from the Serial Port Buffer.
   The streaming data is read from the serial port and then tested for certain conditions. if a packet header is received, then any data collected up to that point is discarded (i.e. the buffer is cleared). If a packet footer is received, then the packet is processed, otherwise the data is added to the buffer.
   The valid packets can be, for example, any of the following:
      Heartbeat,
      Caller ID information, or
      Event Data.
   3.5.2.1. Packet Formats
      All alarm receivers use a different packet format, but all contain the same basic information. The following definition is an example taken from the Radionics D6600 32 Line Alarm Receiver.
         H Header
         M Message Type
         RR Receiver Number (00 to 99)
         L Line Number (1 to 9 and A to W giving a total of 32 lines)
         D Data defined by the Message Type
         F Footer (typically Hex 14 [DC4])
      3.5.2.1.1. Heartbeat Packet
         Message type ‘1’ indicates a heartbeat message. The heartbeat message is also identified by the ‘@’ character in byte position 17, as shown in FIG. 6. The ‘s’ characters represent spaces.
      3.5.2.1.2. Caller ID Packet
         Message type ‘e’ indicates a Caller ID message, as shown in FIG. 7.
         The Caller ID information is defined as 16 bytes, right justified and left padded with spaces. The Caller ID information applies to all subsequent events that are received with the Line No ‘L’.
      3.5.2.1.3. Event Data Packet
         All packets other than the heartbeat and caller id messages are considered to be event packets that need to be delivered to the appropriate destination for processing. However, prior to delivery, the RR (Receiver Number) and L (Line Number) fields are modified as per the subscribers' preferences. This is to ensure that the event is received by the CMS Automation System as if the Alarm Receiver was directly connected to their system.
   3.5.2.2. Operational Flow
      If the Heartbeat is received, the Receiver Status table is updated with the time of the heartbeat. This time will be used in other processing modules to determine the online/offline status of the alarm receiver connection.
      If the Caller ID is received, the Line Status table is updated with the calling phone number (i.e. extension from the PABX) for the record pertaining to the Physical Receiver Number and the Line No (extracted from the message). This will be used to associate any subsequent alarm events with the caller identification.
      If an Alarm Event is received, the Line Number is extracted from the message. This Line Number, together with the Physical Receiver Number, is used to identify the caller id that is associated with the current alarm event. This caller id information is then used to identify the Bureau (or subscriber to this service). The message/packet is reconstructed with the Destination Receiver Number and Line Number as defined for the destination Bureau and then sent to the SG2™ Server for delivery.
      The diagram in FIG. 8 shows the operational flow of events during the processing of received serial data from the alarm receiver.

### 4. Routing Means Overview

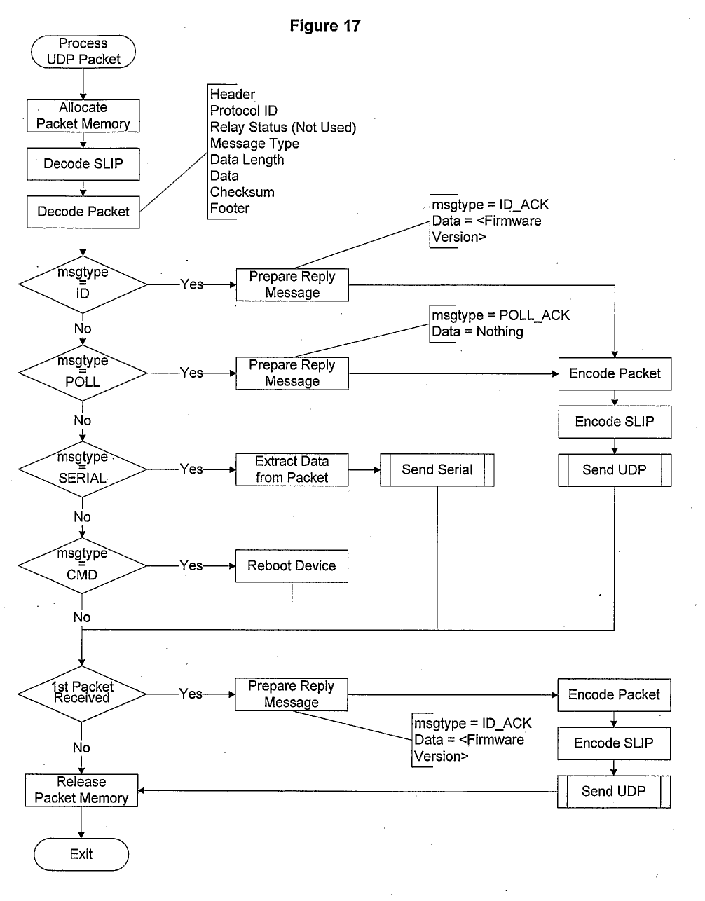

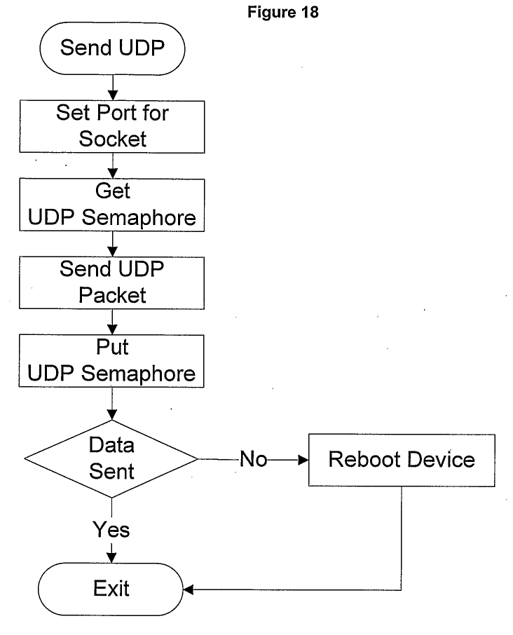

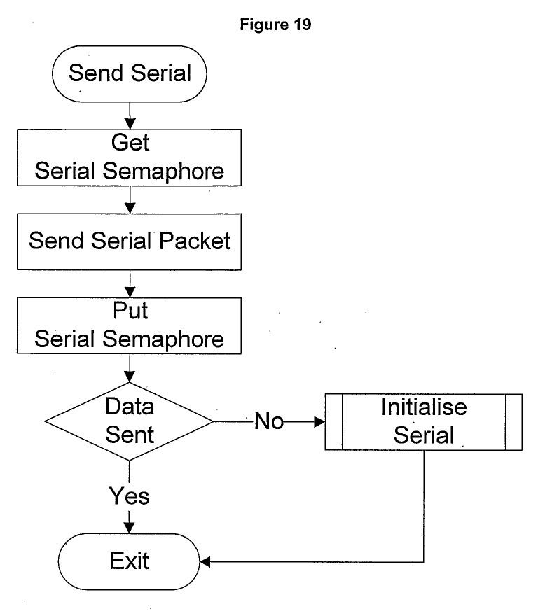

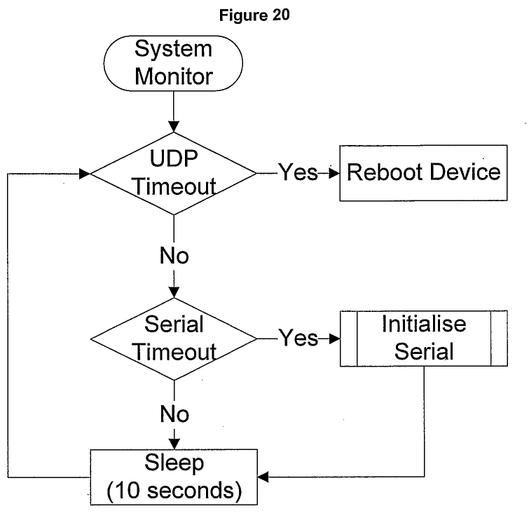

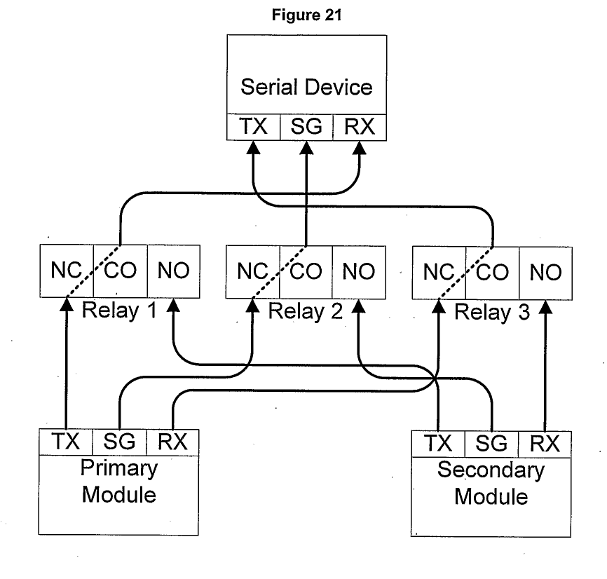

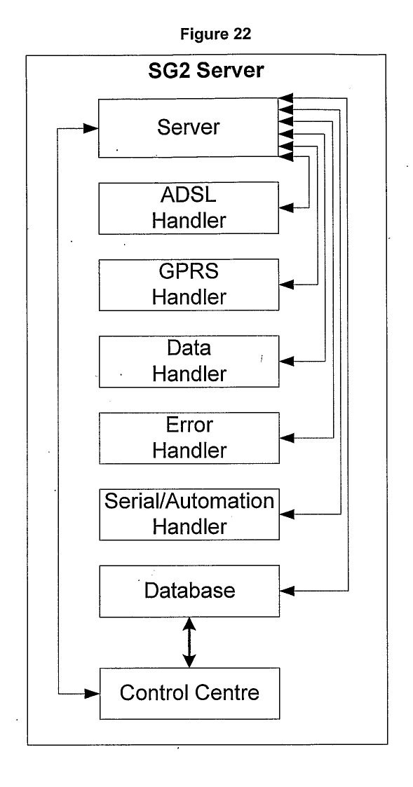

4.1. Routing Means Receiver (Sometimes Referred to as a SG2™ Gateway in the Specification and Figures)
4.1.1. Overview
   The SG2™ Gateway offers two-connection paths to the Routing means server.
   The Primary connection is across an encrypted Virtual Private Network (VPW) via an ADSL service to the SDC.
   The Secondary path is across an encrypted VPN via a GPRS service to the SDC.
   The connection to the automation system at the Central Monitoring Station (CMS) is via a RS232 serial connection that intelligently switches between the primary and secondary modules.
4.1.2. Primary Module Operation
   The primary module executes four threads (or handlers). These include Remote Software Upgrade (RSU) Handler, Serial Data Handler, User Datagram Protocol (UDP) Data Handler, and a System Monitor. These are described in more detail below.
   4.1.2.1. Initialize RSU Handler
      The RSU Handler operates as a File Transfer Protocol (FTP) Server. This service is only available from within the Suretek VPN and requires user and password authentication as an extra level of security. The application upgrade is transferred to the primary module, verified and then written to the permanent memory on the module. Once the above tasks are complete, the module automatically restarts with the new software.
   4.1.2.2. Initialize Serial
      The initialization of the serial thread involves the setting of the communication port parameters, resetting the activity timers (i.e. Last Receive Time), allocating memory space, creating a semaphore to ensure single use of the port at all times, and starting the handler to service the inbound serial data.
   4.1.2.3. Initialize UDP
      The initialization of the UDP thread involves resetting the activity timers (i.e. Last Receive Time), allocating memory space, creating a semaphore to ensure single use of the port at all times, setting the communication parameters to allow connectivity from the SG2™ Server, and starting the handler to service the inbound UDP data.
   4.1.2.4. Serial Data Handler
      The Serial Data Handler is responsible for reading data from the serial port. This is the data that is sent from the CMS Automation system.
      This handler enters a continuous loop of extracting individual packets from the serial data stream.
      When any data is received, the Last Receive Time is set and the serial activity indicator LED is turned ON, and the loop continues. However, if no data is received then the handler sleeps for a predetermined time and the serial activity indicator LED is turned OFF. If the packet header (in this case a Line Feed character) is received, the storage buffer is cleared,
      If any valid packet footer is received (in this case the Carriage Return, ACK, NAK or DC4 characters) then the packet is processed. The processing of the serial data is described later in this specification. If any data other than a header or footer is received, it is added to the buffer and the loop is continued.
   4.1.2.5. UDP Data Handler
      The UDP Data Handler is responsible for reading data from the Ethernet port. This is the data that is sent from the SG2™ Server. This handler enters a continuous loop of extracting individual-packets from the Ethernet data stream.
      When any data is received, the Last Receive Time is set and the Ethernet activity indicator LED is turned ON, and the loop continues. However, if no data is received then the handler sleeps for a predetermined time and the Ethernet activity indicator LED is turned OFF.
      If the packet header is received, the storage buffer is cleared.
      If the packet footer is received then the packet is processed. The processing of the UDP Packet is described later in this document
      If any data other than a header or footer is received, it is added to the buffer and the loop is continued.
   4.1.2.6. Process Serial Packet
      The serial packets are not processed locally by the SG2™ Gateway, but by the SG2™ Server. This means that all serial packets need to be sent to the S®2™ Server as UDP Packets via the Ethernet connection.
      This involves preparing a UDP Packet with the correct header Information. The serial data is encapsulated within the UDP Packet's data field. The UDP Packet is then encoded using SLIP and sent to the SG2™ Server via the UDP Data Port.
   4.1.2.7. Process UDP Packet
      The UDP Packets that are received by the SG2™ Gateway are in the form of requests. These requests can be one of the following:
         ID (request for firmware version and build date),
         Poll (request acknowledgment for alive status),
         Serial (request to send data to serial device; CMS Automation System), or
         Command (Request to perform a local system reboot).
      The first stage of the UDP Packet processing is to remove the SLIP encoding. The packet is then decoded and the packet fields are identified. These fields are listed below:
         Protocol ID,
         Relay Status (Only used by the Secondary Path),
         Message Type (these message types are defined above),
         Data Length,
         Data, and
         Checksum (verification to ensure that packet was not corrupted during transportation).
      If the Message Type is an ID Request, a reply packet is generated with the Message Type field set to ID-ACK₁ the Data field set to the version information, the Data Length field is set to the length of the version information, and the Checksum field is calculated. This packet is then SLIP encoded and sent to the UDP connection. If the Message Type is a Poll, a reply packet is generated with the Message Type field set to POLL-ACK, the Data field is empty, the Data Length field is set to 0, and the Checksum is calculated. This packet is then SLIP encoded and sent to the UDP connection.
      If the Message Type is a Command Request, no reply packet is generated. The system shuts down and restarts.
      If the Message Type is a Serial Request, no reply packet is generated. The data is extracted from the packet and sent directly to the serial device (CMS Automation System). The. receipt acknowledgement for this message will be generated by the CMS Automation System and then sent to the SG2™ Server (Refer to the section of the specification dealing with Process Serial Packet).
      The first UDP Packed that is received after a system restart triggers the unsolicited sending of the ID_ACK message. This contains the firmware version information (see definition above).
      The diagram in FIG. 17 illustrates this operation.
   4.1.2.8. Send to UDP
      The Send to UDP function is quite simple. The send port is set for the UDP Socket and the packet (prepared by the previous level of ‘execution) is sent to the SG2™ Server. If the data send fails the system performs an automatic shutdown and restart.
      The purpose of the Get and Put Semaphore steps are to ensure exclusive use of the UDP Port.
   4.1.2.9. Send to Serial
      The Send to Serial function is quite simple. The packet (prepared by the previous level of execution) is sent to the CMS Automation System via the serial port. If the data send fails, the system performs an automatic re-initialization of the serial port. The purpose of the Get and Put Semaphore steps are to ensure exclusive use of the Serial Port.
   4.1.2.10. SystGm Monitor
      The System Monitor performs a continuous check of the UDP and Serial activity, In particular, it checks the Last Received Times for both the Serial and UDP Ports. If no UDP data has been received for a period greater than the predetermined timeout, then the system automatically performs a shutdown and restart.
      If no Serial data has been received for a period greater than the predetermined timeout, then the system automatically re-initializes the Serial Port (refer to the section in the specification dealing with the Initialize Serial component).
4.1.3. Secondary Module Operation
   The Secondary Module operates in a similar Way to that of the Primary Module.
   The major difference is the transport path; the Primary Module uses a VPN on an ADSL connection, while the Secondary Module uses a VPN on a GPRS connection.
   The Remote Software Upgrade (RSU) service for the Secondary Module is via GPRS using a modified XModem Protocol. The RSU operation is triggered by a Command Message that contains the IP Address and Port from where new firmware can be downloaded across a UDP connection.
   The Secondary Module controls a set of relays. These relays are triggered by a Command Message from the SG2™ Server and serve purposes, such as the following:
   1. Cycle power to the ADSL Modem and the Primary Module. This is a way of remotely rebooting the ADSL Modem and the Primary Module as a method of recovering from a ‘dead’ internet connection.
   2. Control the ‘owner’ of the serial device. This is a way of having two modules, that are both connected to the serial device, without the risk of them interfering with one another.
   4.1.3.1. Relay Operation
      The electrical wiring of the serial lines (Transmit, Receive and Signal Ground) via the relays is such that the normal state sets the Primary Module as the owner of the serial lines. Energizing these relays changes the serial line ownership to the Secondary Module. This wiring ensures that if the Secondary Module loses power or reboots then the serial lines will automatically belong to the Primary Module.
      The Secondary Module also has a timer that checks the UDP activity (or lack thereof). If no UDP traffic is observed beyond a configurable time threshold, then the relays revert back to their normal state (i.e. belong to the Primary Module). The diagram in FIG. 21 shows the wiring that allows these two modules to co-exist
      The diagram in FIG. 21 shows the serial line connections between the Primary Module, Secondary Module and the Serial Device via 3 relays,
         NC Normally Closed NO Normally Open
         CO Common
         TX Transmit Line
         SG Signal Ground
         RX Receive Line
      The dotted lines represent the normal relay state. In this state the TX, RX and SG lines from the Primary Module terminate at the serial device, while that of the Secondary Module are floating. When the Secondary Module energizes these relays, the connection will change from the Normally Closed state to the Normally Open state and hence making the TX, RX and SG lines from the Secondary Module terminate at the serial device, while that of the Primary Module are floating.
      Since the operation of these relays is controlled by the SG2™ Server via UDP message commands across the GPRS network, a state could be entered where the communications between the SG2™ Server and the Secondary Module on the SG2™ Gateway are lost To cater for such a situation, the Secondary Module employs a timed system check that releases the relays where the time since the last received UDP data has exceeded the allowable threshold, giving control back to the Primary Module.

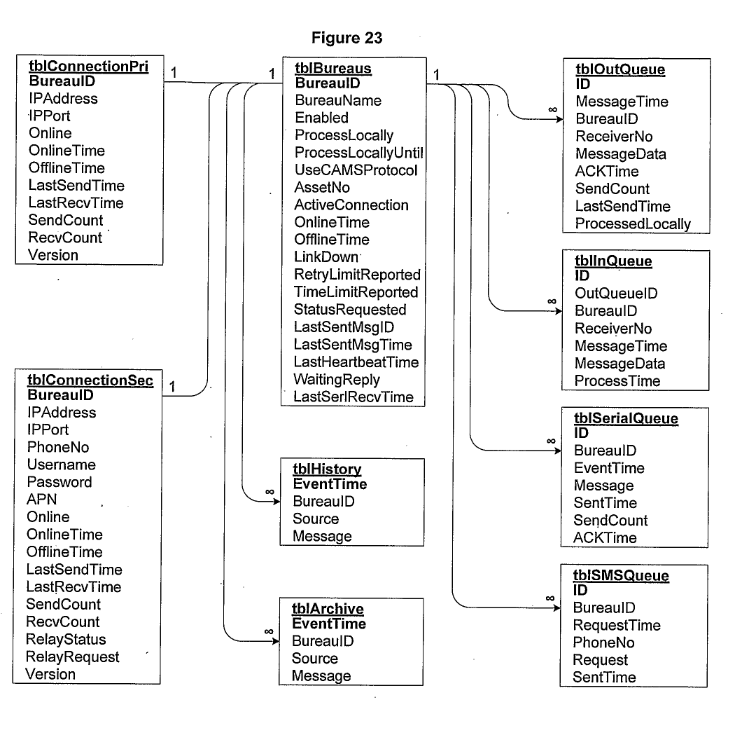

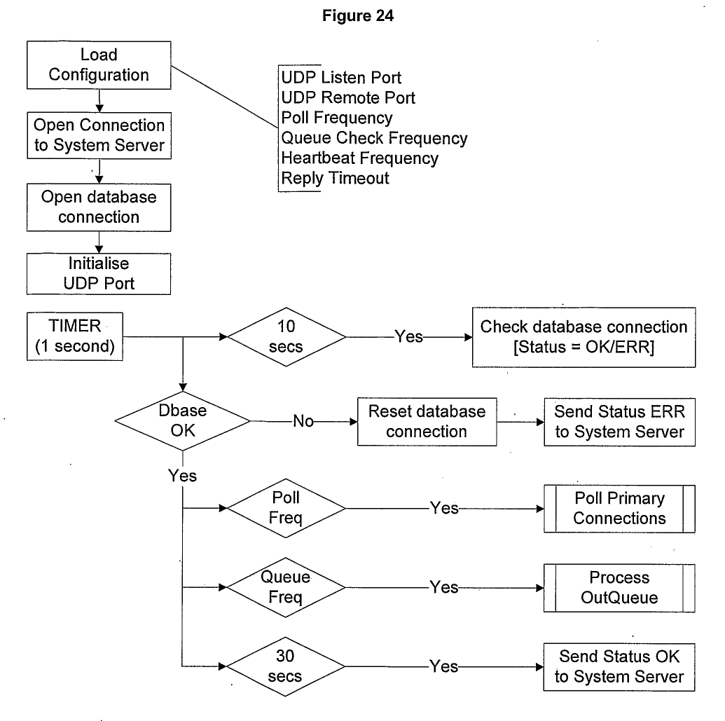

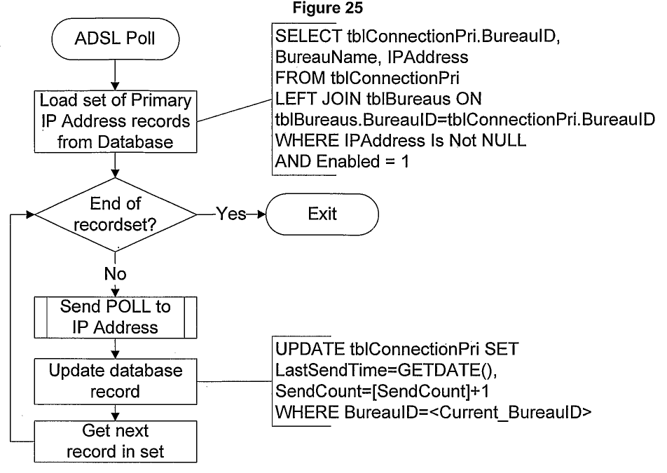

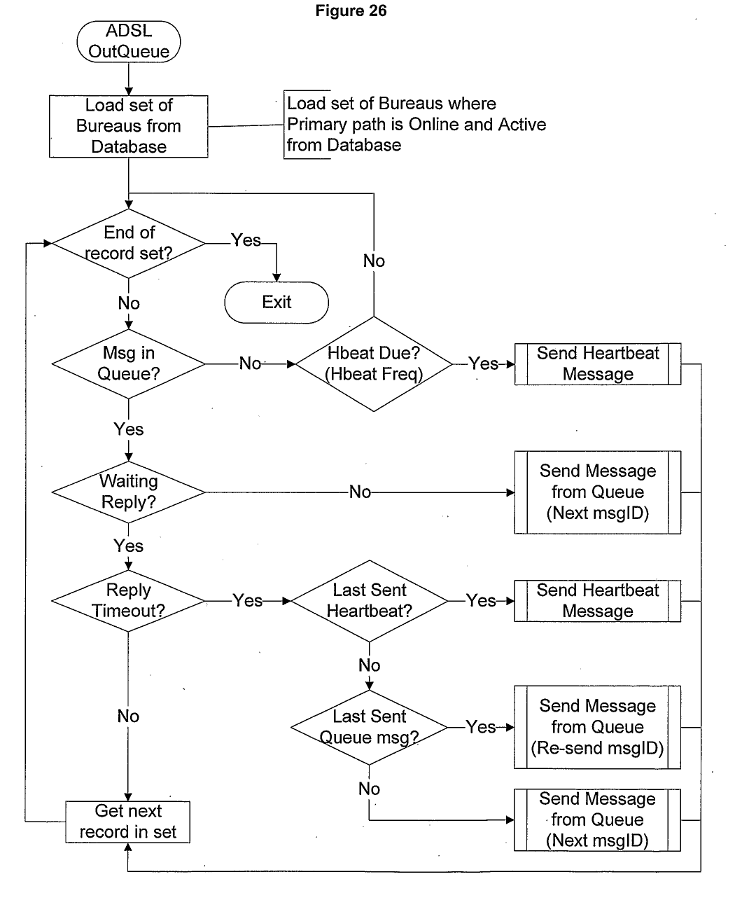

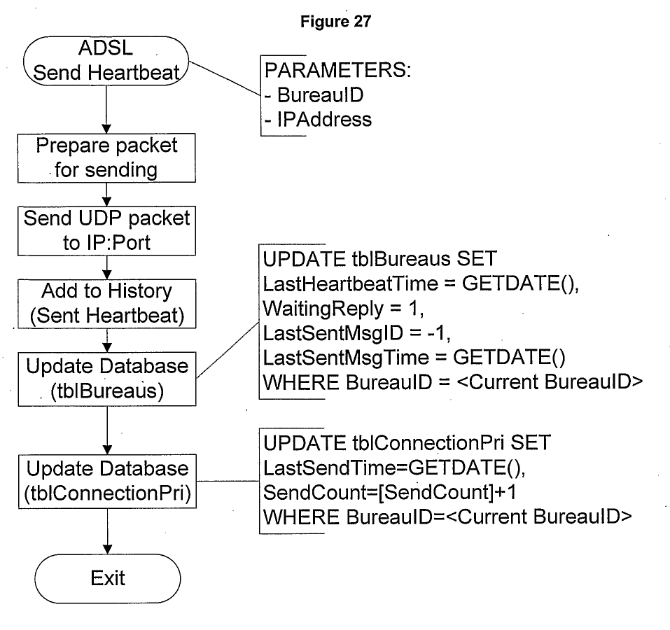

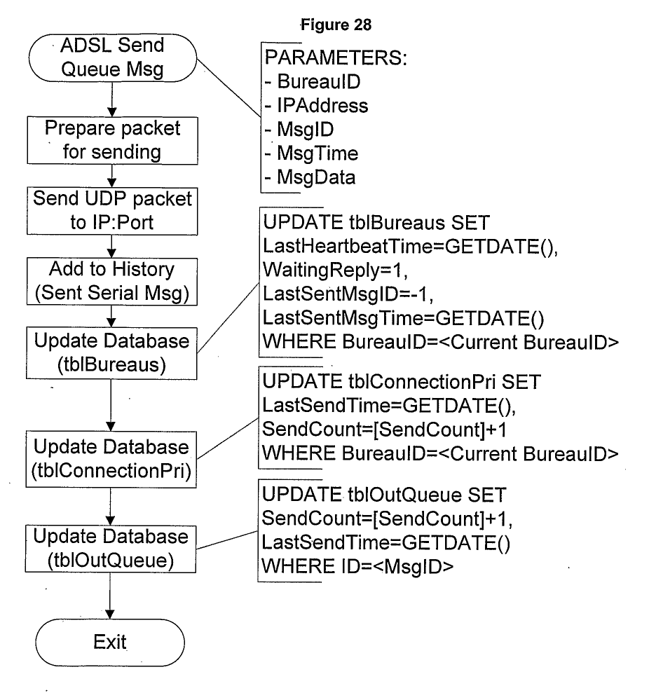

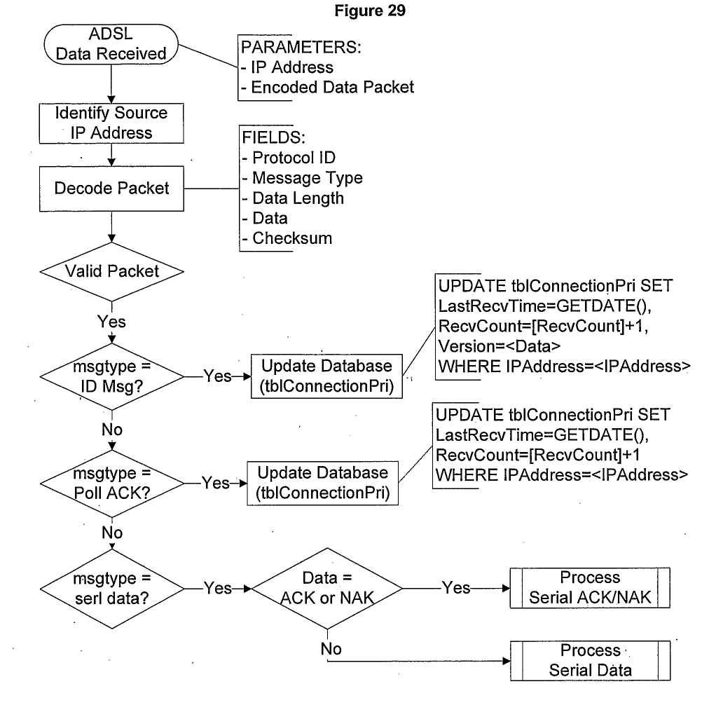

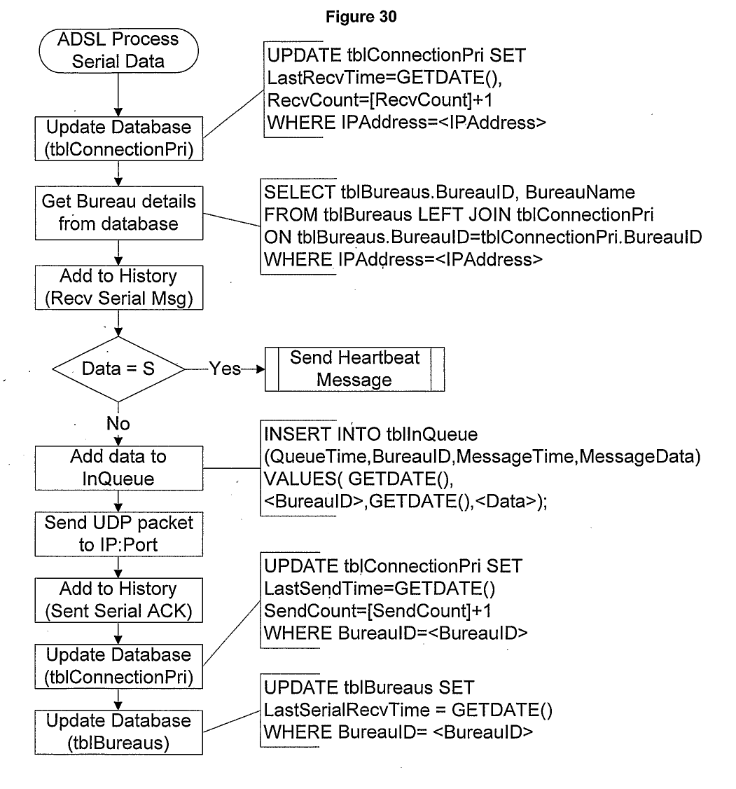

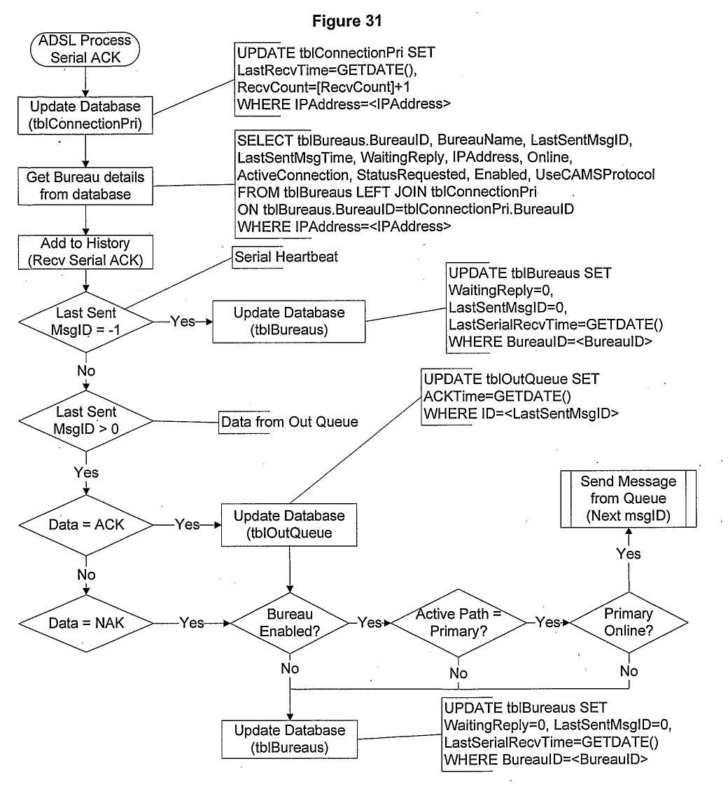

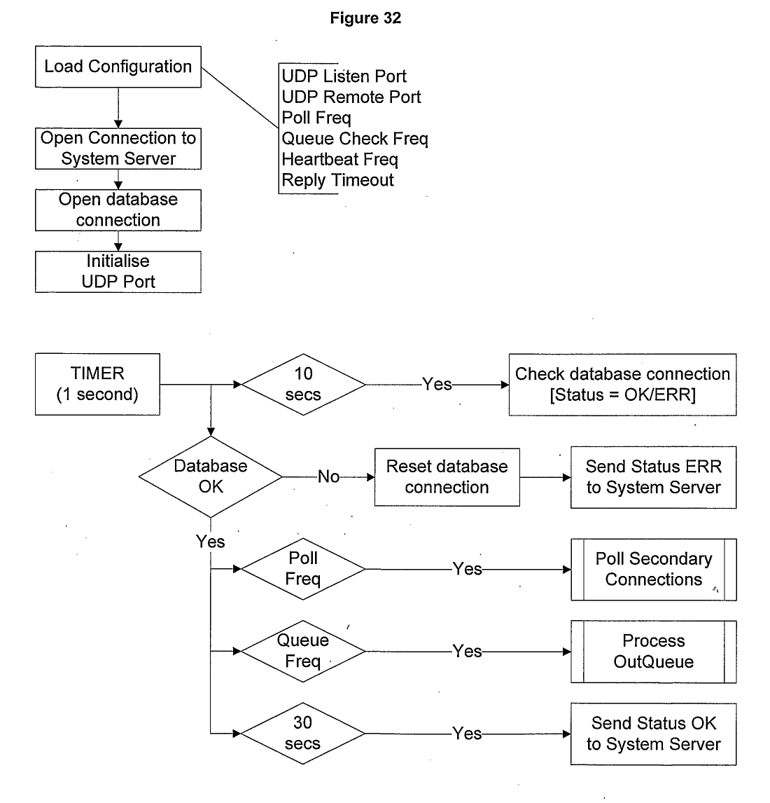

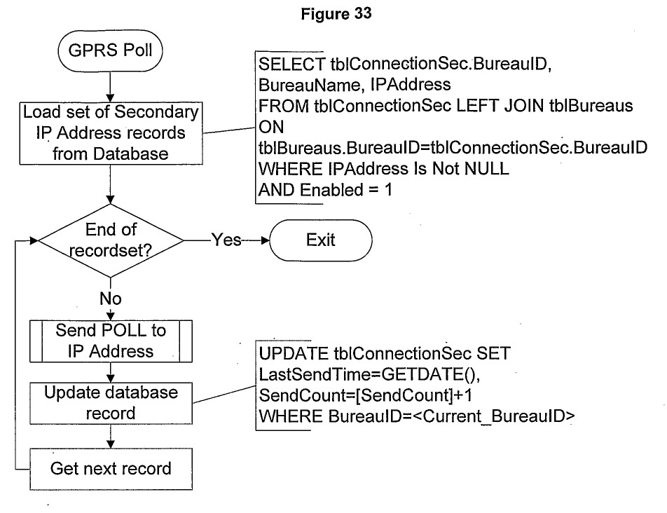

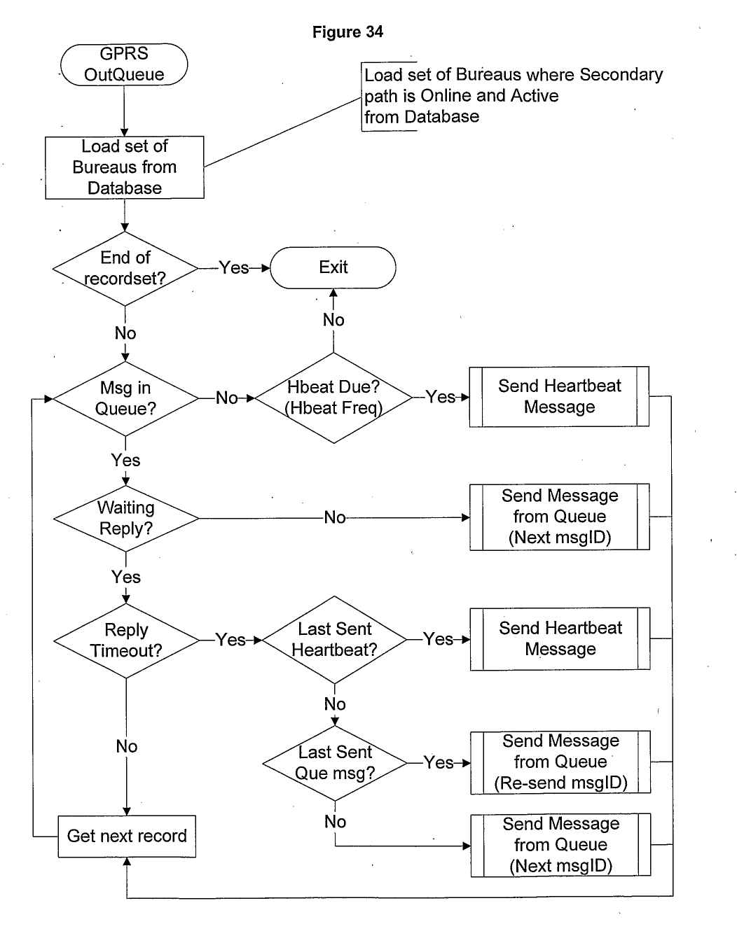

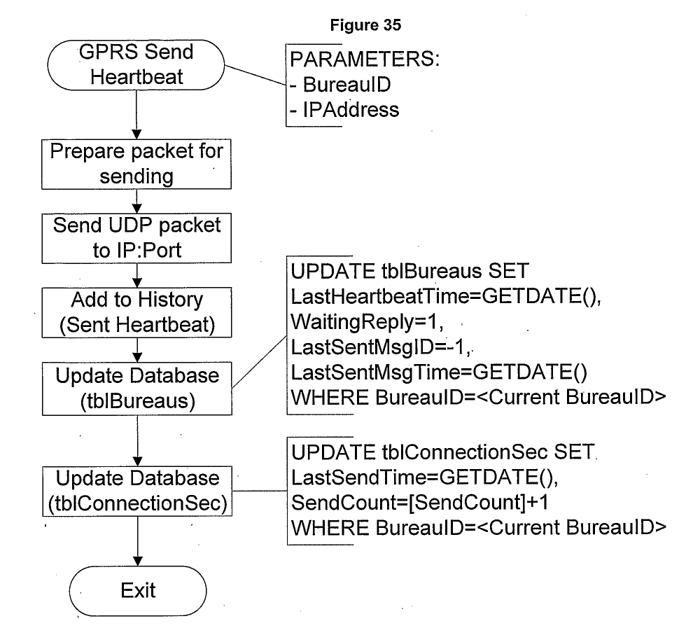

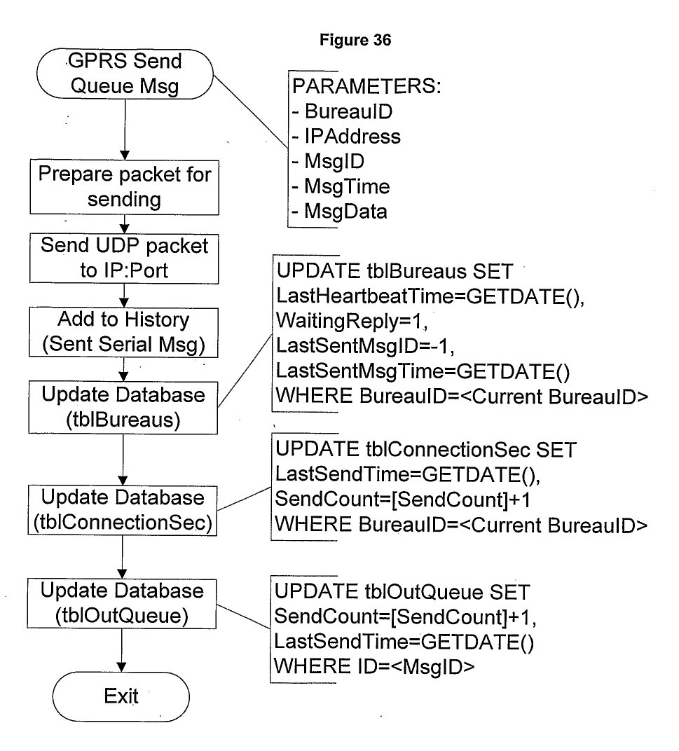

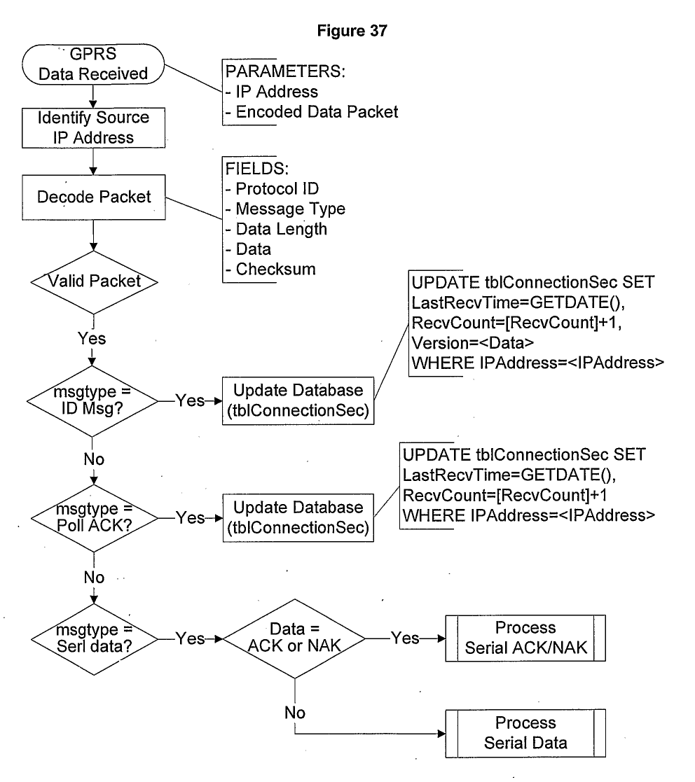

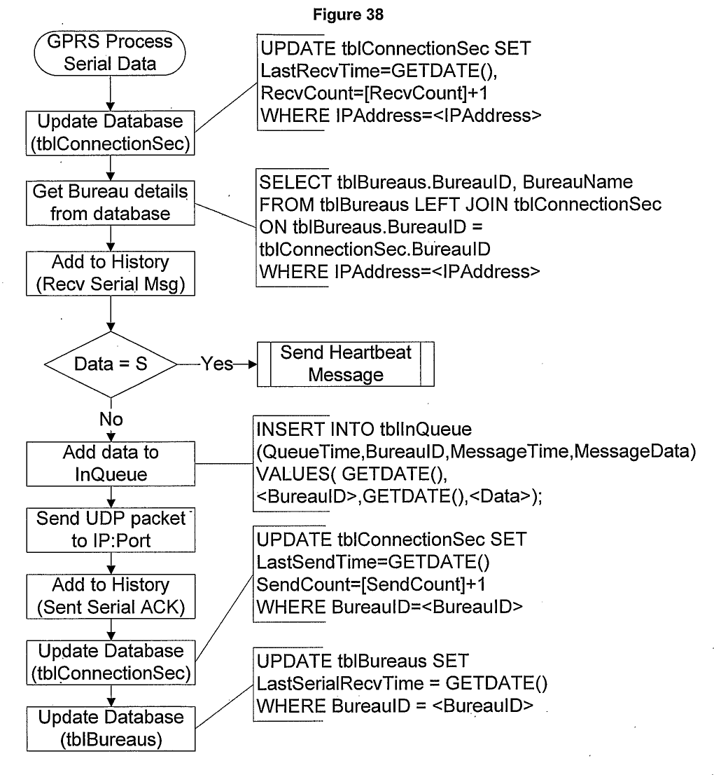

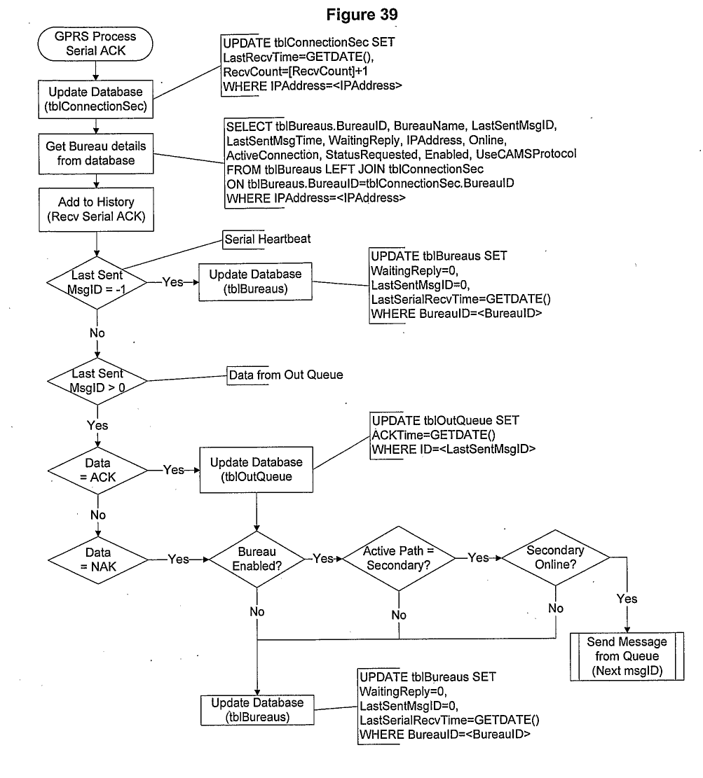

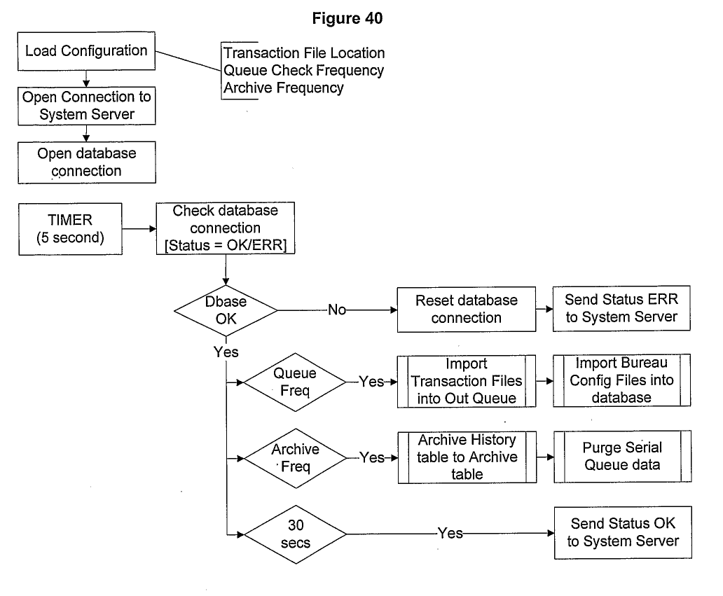

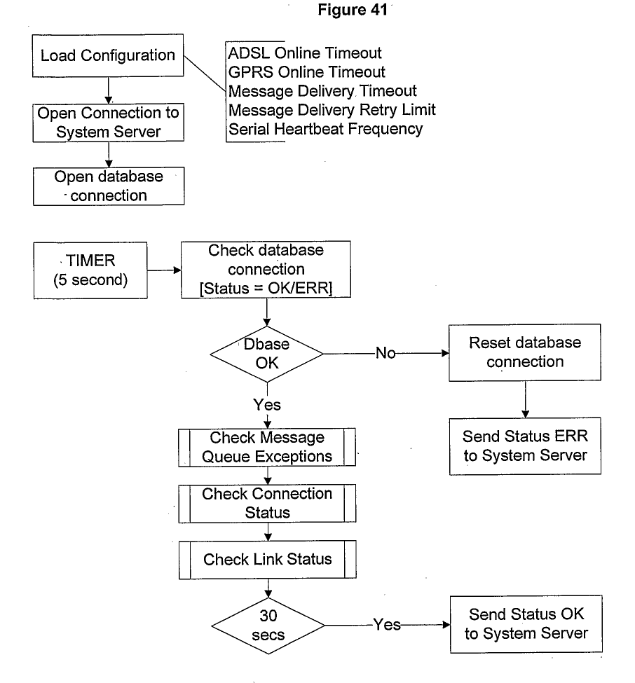

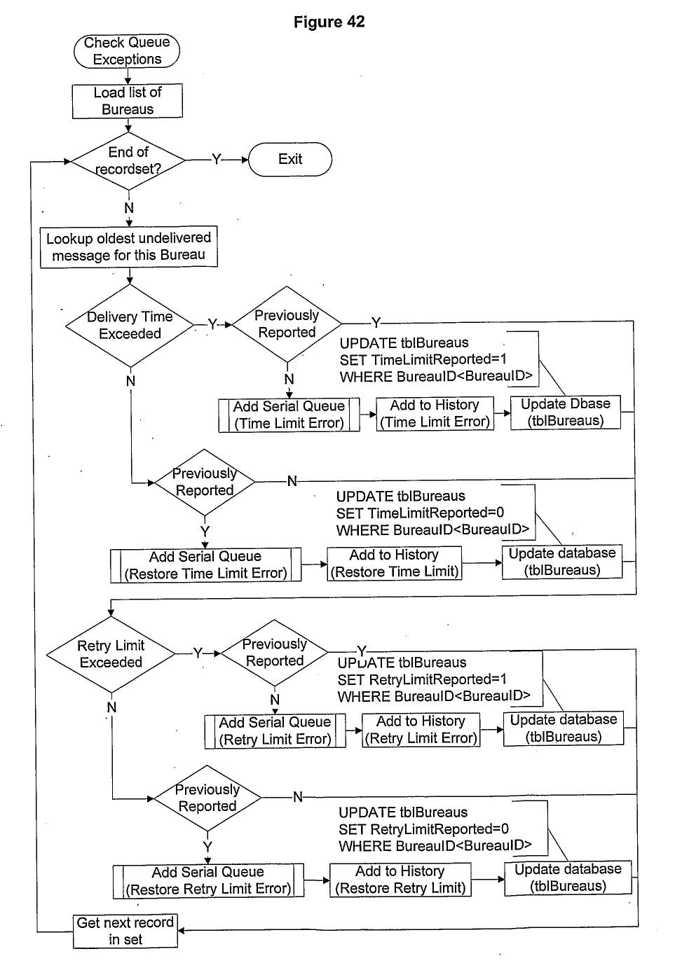

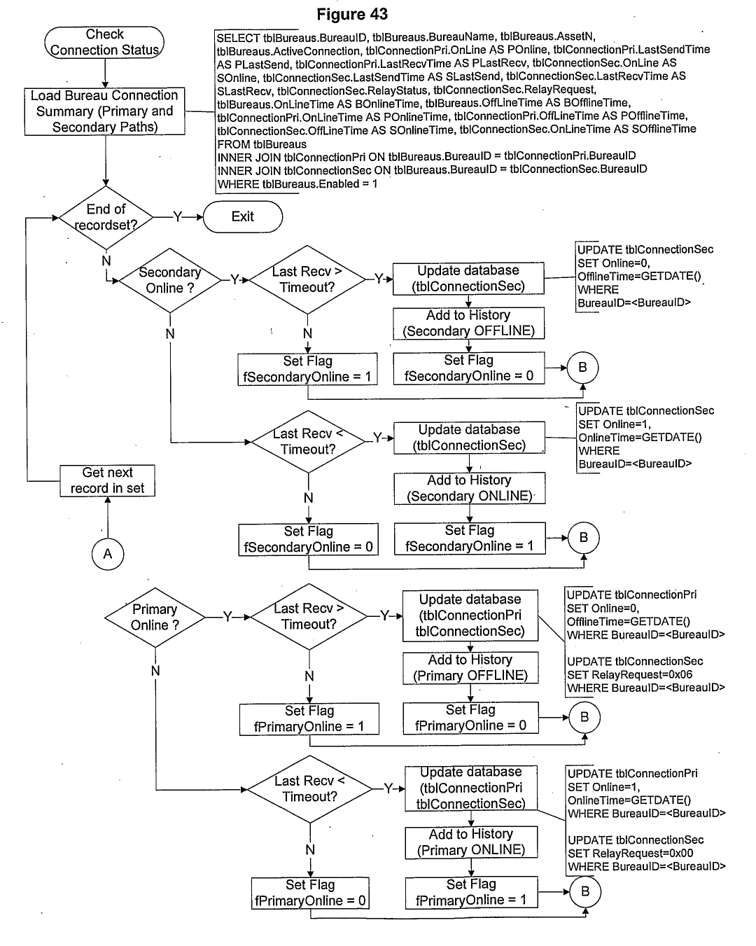

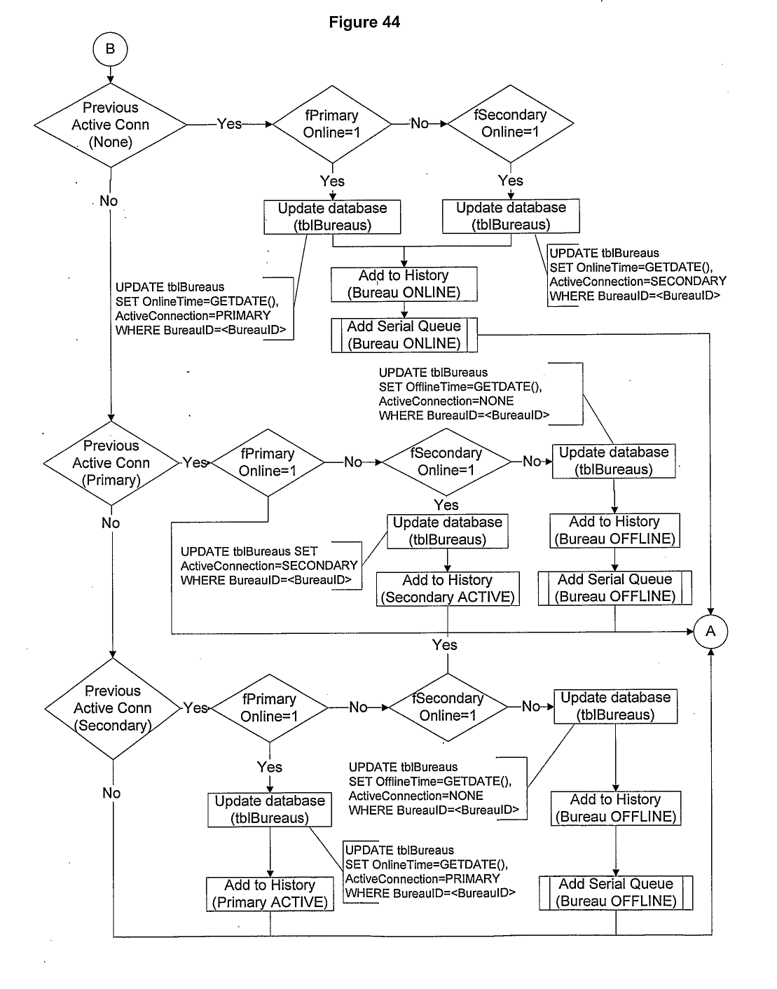

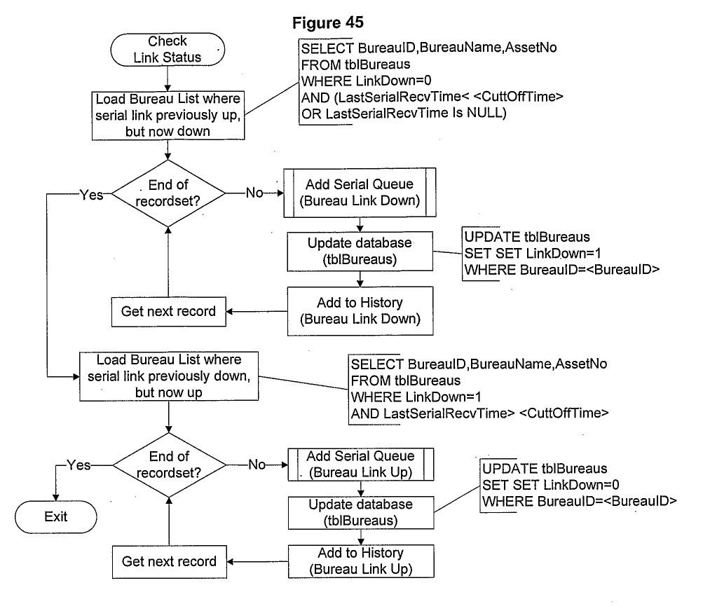

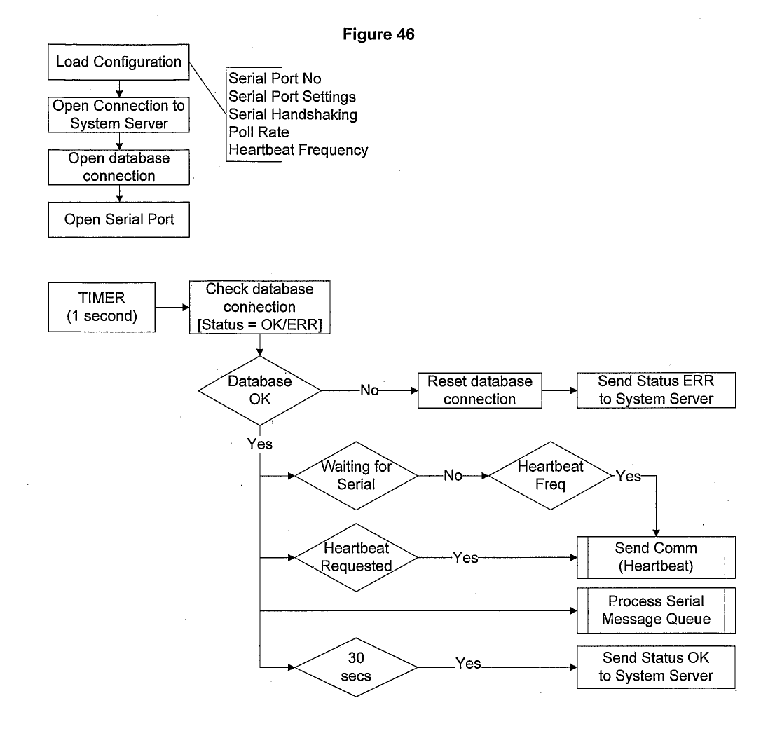

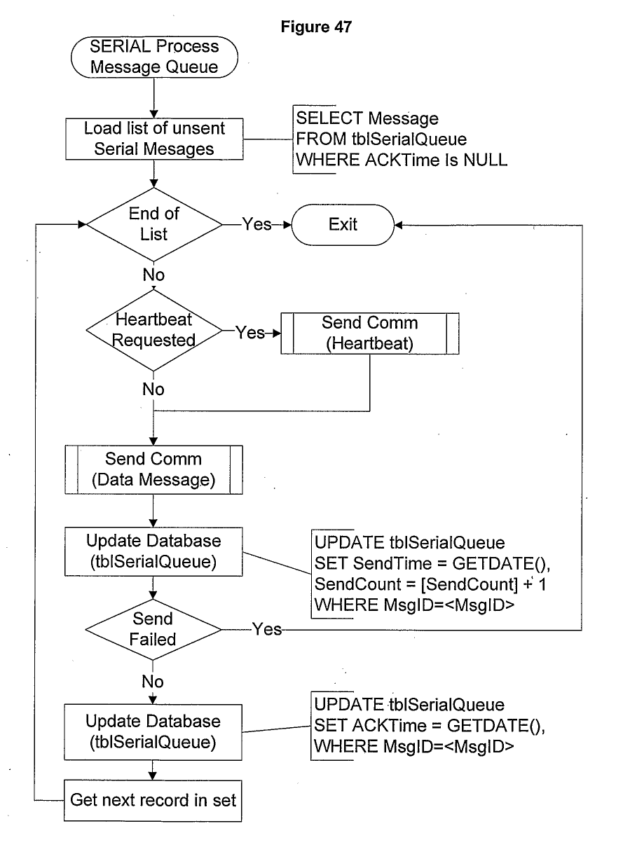

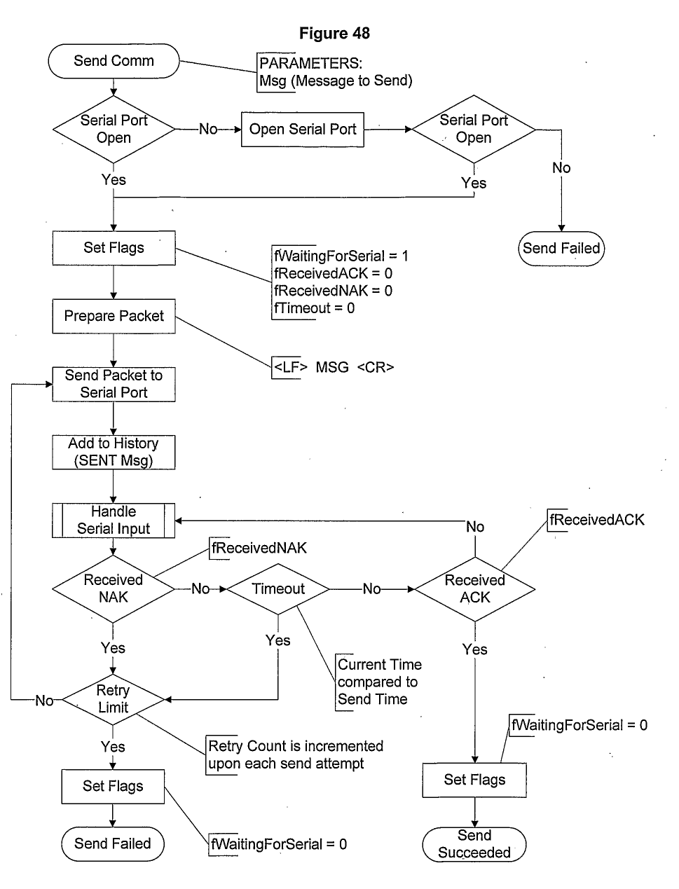

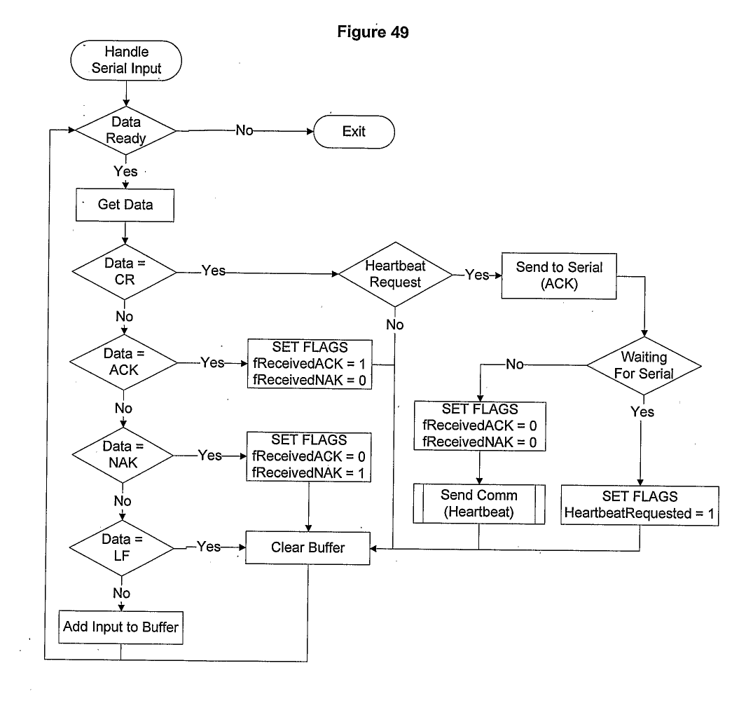

4.2. Routing Means Server {Also Referred to as SG2™ Server in the Specification and Figures)
The SG2™ Server comprises several modules; each performing their dedicated tasks. All tasks that are performed by each of the modules are centered around the SG2™ Database.
The Server module is responsible for spawning and monitoring the status of each of the other modules (ADSL Handler, GPRS Handler, Data Handler, Error Handler and Automation Handler). The operation that is performed by each of these modules is detailed later in this specification, The Server Module also checks the database connectivity and the network path availability (Firewalls, Gateways, Routers, etc).
The Server Module also acts as a message agent. Each module posts their activity to the Server module and the Server module relays these messages to all connected Control Centre clients. The Control Centre client is a GUI, which can run on any workstation on the LAN, and is used for system configuration and activity monitoring.
4.2.1. SG2™ Server Database
   The SG2™ Database is made up of 7 tables.
   The main table (tblBureaus) contains all of the information related to the Bureau (or subscriber to the services). The tables that contain the connection information are the tblConnectionPri and tblConnectionSec (Primary and Secondary paths). Adding a tertiary path requires the addition of a table called tblConnectionTer, and similarly for any additional alternate paths to the SG2™ Gateway.
   The table tblOutQueue contains data messages that are to be sent to the Bureau (CMS Automation system via the SG2™ Gateway).
   The table tblInQueue contains data messages that have been received from the Bureau (CMS Automation system via the SG2™ Gateway).
   The table tblSerialQueue contains event information that is destined for the SDC automation system, such as ‘Bureau OFFLINE’, ‘Bureau ONLINE’, ‘Bureau Time Limit Exceeded’, etc.
   The table SMSQueue contains messages that are queued to be delivered to the SG2™ Gateway's GPRS module via SMS. These messages are typically operational configuration changes.
   The table tblHistory contains records of all activity in the system. These include Bureau connection status changes (ONLINE, OFFLINE) and any data messages that have been sent to and received from the Bureau's SG2™ Gateway. The data from this table that is older than a predetermined age is transferred to the table tblArchive. For example, the table tblHistory contains data only as old as 5 days, while the table tblArchive contains data older than 5 days.
   The diagram in FIG. 23 shows how each of these tables relates to one another. The relationships are based around the BureaulD field and are either one-to-one or one-to-many.
4.2.2. Primary Path (ADSL)
   The Primary Path service (or ADSL Handler) is responsible for several tasks, including, for example:
      Monitoring the connection status of the primary path to all of the Bureaus (or subscribers to the Suretek services),
      Monitoring the connection status of the CMS Automation System's serial link,
      Delivering data (tblOutQueue) to the CMS Automation System via the SG2™ Gateway's Primary Module, and • Receiving data (tblInQueue) from the CMS Automation System via the SG2™ Gateway's Primary Module.
   The parameters used by the ADSL Handler Server module include:
      UDP Listen Port (receive inbound data)
      UDP Remote Port (send outbound data)
      Poll Frequency (rate at which poll messages are sent to the SG2™ Gateway)
      Queue Check Frequency (rate at which the database table tblOutQueue is checked for new messages)
      Heartbeat Frequency (rate at which poll messages are sent to the CMS Automation system)
      Reply Timeout (time to wait for a response before attempting to resend the same message)
   Upon startup, the ADSL Module loads the above configuration parameters, opens a connection back to the SG2™ Server Module (for the purpose of reporting activity as well as any error conditions), opens a connection to the SG2™ Database and Initializes the UDP Port for receiving inbound data, and starts a 1 second timer that triggers the above mentioned tasks.
   The diagram in FIG. 24 illustrates the operation of the SG2™ Server's ADSL Handler.
   4.2.2.1. Send Message
      The fields of the inbound and outbound packets are detailed below:
         Header (used by SLIP encoding)
         Protocol 1 D (reserved for future use)
         Relay Status/Request (Status is received and Request is sent)
         Message Type (used to identify the purpose of the message)
         Data Length (length of the data field)
         Data (information sent and received)
         Checksum (used as message corruption verification)
         Footer (used by SLIP encoding)
      The Relay Status/Request field is not used by the Primary Path. Refer to Section 4.2.3.1 for further details regarding the operation and purpose of the Relay Status/request field.
   4.2.2.2. Poll Primary Connection
      The Poll task is triggered every ‘Poll Frequency’ seconds.
      The Poll task starts by loading a list (from the database) of the IP Addresses of all of the enabled Bureaus that have a valid Primary Path defined.
      As each Poll message is sent to the Bureaus in this list (IP Address), their ‘Send Count’ is incremented and the ‘Last Send Time’ is updated.
      The diagram in FIG. 25 illustrates the operation of the SG2™ Server's Poll Primary Connection function.
   4.2.2.3. OutQueue Handling
      The Primary Connection OutQueue Handler loads the set of Bureaus from the database that has their active path set to the Primary Connection and is currently marked as ‘ONLINE’.
      The outbound message queue is checked for each of the bureaus in the above list.
      If there are no queued outbound messages for that bureau, then a check is made to see if the Heartbeat message is due. If the Heartbeat message is due, it is sent If there is at least one message in the outbound queue, then a check is made to verify if a previously sent message is still waiting for a reply.
      If not waiting for a reply, then the next message in the outbound queue is sent.
      If the system is waiting for a reply from that Bureau and Reply Timeout threshold has expired, and the last sent message was a Heartbeat message, then the Heartbeat message is resent. If the system is waiting for a reply from that Bureau and Reply Timeout threshold has expired, and the last sent message was from the outbound queue, then the same outbound queue message is resent. If the system is waiting for a reply from that Bureau and Reply Timeout threshold has expired, and the last sent message was not a Heartbeat message nor an outbound queue message, then the next outbound queue message is sent.
      If the system is waiting for a reply from that Bureau and Reply Timeout threshold has not expired, then that Bureau is ignored for this cycle and the next Bureau in the list is considered.
   4.2.2.4. Send Heartbeat
      The Heartbeat message is used to allow the CMS Automation System to know that the SG2™ Server is connected and also to allow the SG2™ Server to know that the CMS Automation System is connected.
      The Send Heartbeat function is triggered by the Heartbeat Timer, or when there are no pending outbound queue messages to be sent The required parameters are the BureaulD and the Bureau IP Address.
      The packet is prepared (i.e. SLIP encoded, etc) and sent to the specified IP Address.
      This operation is recorded in the History table. The Bureau table and the Primary Connection table are updated with flags and values to reflect the last operation. Refer to the diagram in FIG. 27 for a description of the flow of events, 4.2.2.5. Send Message Queue
      The Send Message Queue function is triggered by the Queue Frequency Timer or upon receiving an Acknowledgement for a previously sent message.
      The required parameters are the Bureau ID, IP Address, Message ID, Message Time and Message Data. The packet is prepared (i.e. data added to packet, SLIP encoded, etc) and sent to the specified IP Address.
      This operation is recorded in the History table. The Bureau table, Primary Connection table and the OutQueue tables are updated with flags and values to reflect the last operation. Refer to the diagram in FIG. 28 for a description of the flow of events.
   4.2.2.6. Data Arrival
      This function is triggered whenever data is ready to be collected from the UDP Port Buffer (TCP Stack).
      The information that is available with the data is the source IP Address and the encoded packet. The packet is decoded (i.e. SLIP and field extraction) and validated.
      Valid packets can be either of the following Message Types:
         ID Message (Firmware Version information),
         Poll ACK (response from a previously sent poll message), or
         Serial Data (response from a previously sent heartbeat or data message, or a an unsolicited data message/request sent from the CMS Automation System)
      If the Message Type is an ID_ACK then the Primary Connection table record for the received IP Address (current Bureau) is updated with the firmware version of the SG2™ Gateway's Primary Path Module, the Last Receive Time is updated and the Receive Counter is incremented.
      If the Message Type is a POLL_ACK then the Primary Connection table record for the received IP Address {current Bureau) is updated with the current Last Received Time and the Receive Counter is incremented. If the Message Type is SERIAL_DATA then a second check is made to verify if the data is an ACK, NAK or other. If the data is an ACK or a NAK then the Process Serial ACK function is called, otherwise the Process Serial Data function is called. These functions are detailed in subsequent sections of this document.
      The diagram in FIG. 30 illustrates the operation performed upon receiving data from the UDP Port.
   4.2.2.7. Process Serial Data
      This function is triggered by the Data Arrival function described in 4.2.2.6.
      The Primary Connection table is updated with the Last Receive Time and the Receive Counter is incremented.
      The Bureau details are looked up by the IP Address. This information will be required for later use when updating database tables.
      The received data is added to the History table.
      If the received data is ‘S’ (i.e. Heartbeat request initiated by the CMS Automation System), then the Heartbeat message is sent (Refer to Section 4.2.2.4). The Last Serial Receive time is updated in the Bureaus table (This field is used for tracking the ‘alive’ status of the CMS Automation System Connection),
      If the received data is not ¹S’ then the data is added to the table tblInQueue with a reference to the current BureaulD. A reply packet is sent back to the source IP Address (data set to ACK), the Primary Connection table is updated with the current Last Send Time and the Send Counter is incremented. The Last Serial Receive time is updated in the Bureau table (This field is used for tracking the ‘alive’ status of the CMS Automation System Connection).
      The diagram in FIG. 30 illustrates the operations performed during the processing of the Serial Data Packet
   4.2.2.8. Process Serial ACK
      This function is triggered by the Data Arrival function described in 4.2.2.6 when the received data is an ACK or a NAK.
      The Primary Connection table is updated with the Last Receive Time and the Receive Counter is incremented.
      The Bureau details are looked up by the IP Address. This information will be required for later use when updating database tables.
      The received data (ACK/NAK) is added to the History table.
      If the Last Sent Message was a Heartbeat message, then the Bureau table is updated with the Waiting for reply flag reset, the Last Sent Message ID reset and the Last Serial Receive Time set. The Process ends at this point.
      If the Last Sent Message was from the outbound queue and the received data is an ACK, then the outbound queue table is updated with the ACKTime for the last sent message.
      If the Bureau is enabled and the Active Path is the Primary Connection and the Primary Connection is Online, then the Next Message from the outbound queue is sent (refer to Section 4.2.2.5).
      Otherwise, the Bureau table is updated with the Waiting for reply flag reset, the Last Sent Message ID reset, and the Last Serial Receive Time set.
      The diagram in FIG. 31 illustrates the operations performed during the processing of the Serial ACK/NAK Packet.
4.2.3. Secondary Path (GPRS)
   The Secondary Path service (or GPRS Handler) is responsible for several tasks, including, for example:
      Monitoring the connection status of the secondary path to all of the Bureaus (or subscribers to the Suretek services),
      Monitoring the connection status of the CMS Automation System's serial link,
      Delivering data (tblOutQueue) to the CMS Automation System via the SG2™ Gateway's Secondary Module, and
      Receiving data (tblInQueue) from the CMS Automation System via the SG2™ Gateway's Secondary Module.
      The parameters used by the GPRS Handler Server module include:
         UDP Listen Port (receive inbound data)
         UDP Remote Port (send outbound data)
         Poll Frequency (rate at which poll messages are sent to the SG2™ Gateway)
         Queue Check Frequency (rate at which the database table tblOutQueue is checked for new messages)
         Heartbeat Frequency (rate at which poll messages are sent to the CMS Automation system)
         Reply Timeout (time to wait for a response before attempting to resend the same message)
      Upon startup, the GPRS Module loads the above configuration parameters, opens a connection back to the SG2™ Server Module (for the purpose of reporting activity as well as any error conditions), opens a connection to the SG2™ Database and Initializes the UDP Port for receiving inbound data, and starts a 1 second timer that triggers the above mentioned tasks.
      The diagram in FIG. 32 illustrates the operation of the SG2™ Server's GPRS Handler.
   4.2.3.1. Send Message
      The fields of the inbound and outbound packets are detailed below:
         Header (used by SLIP encoding)
         Protocol !D (reserved for future use)
         Relay Status/Request (Status is received and Request is sent)
         Message Type (used to identify the purpose of the message)
         Data Length (length of the data field)
         Data (information sent and received)
         Checksum (used as message corruption verification)
         Footer (used by SLIP encoding)
      The Relay Status/Request field is used by the Secondary Path only. The purpose of the Relay Status is to allow the SG2™ Server to track the state of the SG2™ Gateway's Relays. The purpose of the Relay Request is to allow the SG2™ Server to change the state of the SG2™ Gateway's Relays.
      The SG2™ Gateway's Relays serve purposes including, for example:
      1. Cycle power to the Primary Connection (method of remotely resetting the Primary Module and/or the Primary Module's ADSL modem/router).
      2. Change the ‘owner’ of the serial lines of the SG2™ Gateway (Primary or Secondary)
      For further details regarding the operation of the Relays, please refer to Section 4.1.3.1.
   4.2.3.2. Secondary Path (Poll)
      The Poll task is triggered every ‘Poll Frequency’ seconds.
      The Poll task starts by loading a list (from the database) of the IP Addresses of all of the enabled Bureaus that have a valid Primary Path defined.
      As each Poll message is sent to the Bureaus in this list (IP Address), their ‘Send Count’ is incremented and the ‘Last Send Time’ is updated. The diagram in FIG. 33 illustrates the operation of the SG2™ Server's Poll Secondary Connection function.
   4.2.3.3. OutQueue Handling
      The Secondary Connection OutQueue Handler loads the set of Bureaus from the database that has their active path set to the Secondary Connection and is currently marked as ‘ONLINE’.
      The outbound message queue is checked for each of the bureaus in the above list.
      If there are no queued outbound messages for that bureau, then a check is made to see if the Heartbeat message is due. If the Heartbeat message is due, it is sent. if there is at least one message in the outbound queue, then a check is made to verify if a previously sent message is still waiting for. a reply.
      If not waiting for a reply, then the next message in the outbound queue is sent.
      If the system is waiting for a reply from that Bureau and Reply Timeout threshold has expired and the last sent message was a Heartbeat message, then the Heartbeat message is resent. If the system is waiting for a reply from that Bureau and Reply Timeout threshold has expired, and the last sent message was from the outbound queue, then the same outbound queue message is resent. If the system is waiting for a reply from that Bureau and Reply Timeout threshold has expired, and the last sent message was not a Heartbeat message nor an outbound queue message, then the next outbound queue message is sent. If the system is waiting for a reply from that Bureau and Reply Timeout threshold has not expired, then that Bureau is ignored for this cycle and the next Bureau in the list is considered.
   4.2.3.4. Send Heartbeat
      The Heartbeat message is used to allow the CMS Automation System to know that the SG2™ Server is connected and also to allow the SG2™ Server to know that the CMS Automation System is connected.
      The Send Heartbeat function is triggered by the Heartbeat Timer, or when there are no pending outbound queue messages to be sent.
      The required parameters are the BureaulD and the Bureau IP Address.
      The packet is prepared (i.e. SLIP encoded, etc) and sent to the specified IP Address.
      This operation is recorded in the History table. The Bureau table and the Secondary Connection table are updated with flags and values to reflect the last operation.
      Refer to the diagram in FIG. 35 for a description of the flow of events.
   4.2.3.5. Send Message Queue
      The Send Message Queue function is triggered by the Queue Frequency Timer or upon receiving an Acknowledgement for a previously sent message.
      The required parameters are the Bureau ID, IP Address, Message ID, Message Time and Message Data.
      The packet is prepared (i.e. data added to packet, SLIP encoded, etc) and sent to the specified IP Address.
      This operation is recorded in the History table. The Bureau table, Secondary Connection table and the OutQueue tables are updated with flags and values to reflect the last operation.
      Refer to the diagram in FIG. 36 for a description of the flow of events.
   4.2.3.6. Data Arrival
      This function is triggered whenever data is ready to be collected from the UDP Port Buffer (TCP Stack).
      The information that is available with the data is the source IP Address and the encoded packet. The packet is decoded (i.e., SLIP and field extraction) and validated.
      Valid packets can be either of the following Message Types:
         ID Message (Firmware Version information),
         Poll ACK (response from a previously sent poll message), or
         Serial Data (response from a previously sent heartbeat or data message, or a an unsolicited data message/request sent from the CMS Automation System)
      If the Message Type is an ID ACK then the Secondary Connection table record for the received IP Address (current Bureau) is updated with the firmware version of the SG2™ Gateway's Secondary Path Module, the Last Receive Time is updated and the Receive Counter is incremented.
      If the Message Type is a POLL-ACK then the Secondary Connection table record for the received IP Address (current Bureau) is updated with the current Last Received Time and the Receive Counter is incremented.
      If the Message Type is SERIAL_DATA then a second check is made to verify if the data is an ACK, NAK or other. If the data is an ACK or a NAK then the Process Serial
      ACK function is called, otherwise the Process Serial Data function is called. These functions are detailed in subsequent sections of this document.
      The diagram in FIG. 37 illustrates the operation performed upon receiving data from the UDP Port.
   4.2.3.7. Process Serial Data
      This function is triggered by the Data Arrival function described in 4.2.3.6.
      The Secondary Connection table is updated with the Last Receive Time and the Receive Counter is incremented.
      The Bureau details are looked up by the IP Address. This information will be required for later use when updating database tables.
      The received data is added to the History table.
      If the received data is ‘S’ (i.e. Heartbeat request initiated by the CMS Automation System), then the Heartbeat message is sent (Refer to Section 4.2.3.4). The Last Serial Receive time is updated in the Bureaus table (This field is used for tracking the ‘alive’ status of the CMS Automation System Connection).
      If the received data is not ¹S’ then the data is added to the table tblInQueue with a reference to the current BureaulD. A reply packet is sent back to the source IP Address (data set to ACK), the Secondary Connection table is updated with the current Last Send Time and the Send Counter is incremented. The Last Serial Receive time is updated in the Bureau table (This field is used for tracking the ‘alive’ status of the CMS Automation System Connection).
      The diagram in FIG. 38 illustrates the operations performed during the processing of the Serial Data Packet.
   4.2.3.8. Process Serial ACK
      This function is triggered by the Data Arrival function described in 4.2.3.6 when the received data is an ACK or a NAK.
      The Primary Connection table is updated with the Last Receive Time and the Receive Counter is incremented.
      The Bureau details are looked up by the IP Address. This information will be required for later use when updating database tables.
      The received data (ACK/NAK) is added to the History table.
      If the Last Sent Message was a Heartbeat message, then the Bureau table is updated with the Waiting for reply flag reset, the Last Sent Message ID reset, and the Last Serial Receive Time set. The Process ends at this point.
      If the Last Sent Message was from the outbound queue and the received data is an ACK, then the outbound queue table is updated with the ACKTime for the last sent message.
      If the Bureau is enabled and the Active Path is the Secondary Connection and the Secondary Connection is Online, then the Next Message from the outbound queue is sent (refer to Section 4.2.3.5).
      Otherwise, the Bureau table is updated with the Waiting for reply flag reset, the Last Sent Message ID reset, and the Last Serial Receive Time set.
      The diagram in FIG. 39 illustrates the operations performed during the processing of the Serial ACK/NAK Packet.
4.2.4. Data Handler
   The Data Handler service is responsible for the following tasks:
      Importing transaction files into the outbound queue,
      Importing and updating Bureau (subscriber) configuration into the Bureau and Connection tables,
      Archiving historic events from the History table to the Archive table,
      Purging obsolete Serial Queue table records that have already been reported to the SDC automation system, and
      Purging obsolete SMS Queue table records that have already been delivered to the SG2™ Gateways GPRS Module.
   The parameters used by the Data Handler module include:
      Transaction File location
      Queue Check Frequency
      Archive Frequency
   Upon startup, the Data Module loads the above configuration parameters, opens a connection back to the SG2™ Server Module (for the purpose of reporting activity as well as any error conditions), opens a connection to the S<32™ Database, and starts a 5 second timer that triggers the above mentioned tasks.
   The diagram in FIG. 40 illustrates the operation of the SG2™ Server's Data Handler.
4.2.5. Error/Exception Handler
   The Error (or Exception) Handler service is responsible for several tasks including, for example:
      Checking and reporting changes in the SG2 Gateway Connection Status (i.e. Primary connection OFFLINE, Secondary connection ACTIVE, etc),
      Checking and reporting changes in the Link Status of the CMS Automation System (i.e. Serial device connected to the SG2™ Gateway),
      Checking and reporting the time status of messages in the outbound queue (Le, Undelivered messages that have been in the queue beyond the allowable time threshold), and
      Checking and reporting the retry status of messages in the outbound queue (i.e. Messages that have not been delivered after excessive re-send attempts).
   The parameters used by the Error Handler module include:
      Primary Connection (ADSL Path) Online Timeout
      Secondary Connection (GPRS Path) Online Timeout
      Message Delivery Timeout • Message Delivery Retry Limit
      Serial Heartbeat Frequency
   Upon startup, the Error Module loads the above configuration parameters, opens a connection back to the SG2™¹ Server Module (for the purpose of reporting activity as well as any error conditions), opens a connection to the SG2™ Database, and starts a 5 second timer that triggers the above mentioned tasks.
   The diagram in FIG. 41 illustrates the operation of the SG2™ Server's Error Handler.
   4.2.5.1. Check Queue Exceptions
      The Queue Exception Handler is triggered periodically by the timer discussed in Section 4.2.5.
      This check starts by loading a list of enabled Bureaus from the database.
      The oldest undelivered outbound queue record for this Bureau is. considered for the delivery timeout condition and the delivery retry limit condition.
      If the message has been in the queue longer than the Time Limit Threshold and it has not been previously reported, then an exception event (Time Limit Exceeded) is sent to the SDC automation system; This condition is recorded in the History and the Bureau table is updated to reflect the fact that this exception was reported.
      If this message has not been in the queue longer than the Time Limit Threshold and it has been previously reported, then a restoral for the exception event (Restore Time Limit Exceeded) is sent to the SDC automation system. This condition is recorded in the History and the Bureau table is updated to reflect the fact that this exception has been resolved.
      If the message has been re-sent more times than the Retry Limit Threshold and it has not been previously reported, then an exception event (Retry Limit Exceeded) is sent to the SDC automation system. This condition is recorded in the History and the Bureau table is updated to reflect the fact that this exception was reported.
      If this message has not been re-sent more times than the Retry Limit Threshold and it has been previously reported, then a restoral for the exception event (Restore Retry Limit Exceeded) is sent to the SDC automation system. This condition is recorded in the History and the Bureau table is updated to reflect the fact that this exception has 5 been resolved.
      These steps are then repeated for each Bureau in the list.
      The diagram in FIG. 42 illustrates the operation of the Out Queue Exception Handling.
   4.2.5.2. Connection Status Check
      The Connection Status Check is triggered periodically by the timer discussed in Section 4.2.5.
      The connection status check is used to determine which path should be used for transmitting data to the CMS Automation system.
      This check starts by loading a list of enabled Bureaus including the primary and 5 secondary connection information from the database.
      If the state of the secondary path was previously online and the time since data was last received on this connection path has exceeded the predefined threshold, than the database is updated to indicate that the secondary path is in an offline state and the offline time is set to the current time. The change In state is recorded in the History for 0 this Bureau. A flag is set to indicate that the secondary path is offline. This flag will be used later during the connection status check.
      If the state of the secondary path was previously online and the time since data was last received on this connection path has not exceeded the predefined threshold, then a flag is set to indicate that the secondary path is online, This flag will be used later 5 during the connection status check.
      If the state of the secondary path was previously offline and the time since data was last received on this connection path has exceeded the predefined threshold, then a flag is set to indicate that the secondary path is offline. This flag will be used later during the connection status check.
      If the state of the secondary path was previously offline and the time since data was last received on this connection path has not exceeded the predefined threshold, then the database is updated to indicate that the secondary path is in an online state and the online time is set to the current time. The change in state is recorded in the History for this Bureau. A flag is set to indicate that the secondary path is online. This flag will be used later during the connection status check.
      If the state of the primary path was previously online and the time since data was last received on this connection path has exceeded the predefined threshold, then the database is updated to indicate that the primary path is in an offline state and the offline time is set to the current time. The change in state is recorded in the History for this Bureau. The Secondary Connection table's Relay Request field is updated so that the SG2™ Gateway's Serial output belongs to the Secondary Path (refer to section 4.1.3.1 for a description of the Relay Operation). A flag is set to indicate that the primary path is offline. This flag will be used later during the connection status check.
      If the state of the primary path was previously online and the time since data was last received on this connection path has not exceeded the predefined threshold, then a flag is set to indicate that the primary path is online. This flag will be used later during the connection status check.
      If the state of the primary path was previously offline and the time since data was last received on this connection path has exceeded the predefined threshold, then a flag is set to indicate that the primary path is offline. This flag will be used later during the connection status check.
      If the state of the primary path was previously offline and the time since data was last received on this connection path has not exceeded the predefined threshold, then the database is updated to indicate that the primary path is in an online state and the online time Is set to the current time. The change in state is recorded in the History for this Bureau. The Secondary Connection table's Relay Request field is updated so that the SG2™ Gateway's Serial output belongs to the Primary Path (refer to section 4.1.3.1 for a description of the Relay Operation}. A flag is set to indicate that the primary path is online. This flag will be used later during the connection status check.
      The primary and secondary activity flags are used in the following processing stages.
      If the previously active path for this Bureau was neither the primary nor the secondary and the primary connection is currently active, then the database is updated to indicate that the primary connection is the active path and the Bureau online time is set to the current time. The change in state is recorded in the History and the event is sent to the SDC Automation system via the Serial Queue to inform the operators that this Bureau is back online.
      If the previously active path for this Bureau was neither the primary nor the secondary and the primary connection is currently not active, but the secondary connection is active, then the database is updated to indicate that the secondary connection is the active path and the Bureau online time is set to the current time. The change in state is recorded in the History and the event is sent to the SDC Automation system via the Serial Queue to inform the operators that this Bureau is back online.
      If the previously active path for this Bureau was the primary connection and the primary connection is currently active there is no change in state since the previous check cycle. Since there was no change in state, no further processing is required.
      If the previously active path for this Bureau was the primary connection and the primary connection is not currently active, but the secondary connection is active, then the database is updated to indicate that the secondary connection is the active path. The change in state is recorded in the History.
      If the previously active path for this Bureau was the primary connection and neither the primary connection nor the secondary connection is currently active, then the database is updated to indicate that the Bureau is offline and there are no active paths, The change in state is recorded in the History and the event is sent to the SDC Automation system via the Serial Queue to inform the operators that this Bureau is offline.
      If the previously active path for this Bureau was the second connection, and the primary connection is not currently active, but the secondary connection is currently active there is no change in state since the previous check cycle. Since there was no change in state, no further processing is required.
      If the previously active path for this Bureau was the secondary connection and the primary connection is currently active, then the database is updated to indicate that the primary connection is the active path. The change in state is recorded in the History.
      If the previously active path for this Bureau was the secondary connection and neither the primary connection nor the secondary connection is currently active, then the database is updated to indicate that the Bureau is offline and there are no active paths. The change in state is recorded in the History and the event is sent to the SDC Automation system via the Serial Queue to inform the operators that this Bureau is offline.
      These steps are then repeated for each Bureau in the list.
      The diagrams in FIG. 43 and FIG. 44 illustrate the operation of the Connection Status Check.
   4.2.5.3. Link Status Check
      The Link Status Handler is triggered periodically by the timer discussed in Section 4.2.5. This is a check to verify if the CMS automation system is active or inactive. If the SG2™ Server has received Serial Data messages from the SG2™ Gateway then it is apparent that the Link is active. If the SG2™ Server has not received Serial Data messages from the SG2™ Gateway for a longer time than permitted, then it is presumed that the Link is inactive.
      This check operates in two parts.
      First, a list of Bureaus is loaded where the serial link was previously ACTIVE, but is now INACTIVE (i.e. Last Serial Receive Time is NOT older than the predefined cut-off time).
      An event is sent to the SDC automation system for each Bureau that meets this condition, the action is recorded in the History and the Bureau record is updated to indicate that the link is inactive.
      These steps are repeated for each Bureau in the list.
      Secondly, a list of Bureaus is loaded where the serial link was previously INACTIVE, but is now INACTIVE (i.e. Last Serial Receive Time IS older than the predefined cut-off time).
      An event is sent to the SDC automation system for each Bureau that meets this condition, the action is recorded in the History and the Bureau record is updated to indicate that the link is active.
      These steps are repeated for each Bureau in the list.
      The diagram in FIG. 45 illustrates the operation of the Out Queue Exception Handling.
4.2.6. Serial Handler (Automation System Interface)
   The Serial (or SDC Automation System Interface) Handler service is responsible for several tasks, including, for example:
      Send a periodic heartbeat message to the SDC automation system as an indication that all is okay. If the SDC automation system fails to receive a heartbeat message then it assumes that the SG2™ Server is DEAD and raises appropriate alarms, and
      Send alarm events to the SOC automation system informing it of various exception conditions with the SG2™ Server and any of the Bureau connections (such as Bureau OFFLINE, Bureau ONLINE, Bureau LINK DOWN, etc) via the Serial Queue.
   The parameters used by the Error Handler module include:
      Serial/Communications Port number,
      Serial/Communication Port Settings (baud rate, etc)
      Serial Handshaking
      Poll Rate (rate at which the serial queue is checked)
      Heartbeat Frequency (rate at which the heartbeat message is sent)
   Upon startup, the Serial Module loads the above configuration parameters, opens a connection back to the SG2™ Server Module (for the purpose of reporting activity as well as any error conditions), opens a connection to the SG2™ Database, and starts a 1 second timer that triggers the above mentioned, tasks.
   The diagram in FIG. 46 illustrates the operation of the SG2™ Server's Serial Handler.
   4.2.6.1. Process Serial Message Queue
      FIG. 47 provides a flowchart of the process serial message queue.
   4.2.6.2. Send Serial Data
      The Send Serial Data function is triggered periodically by the timer discussed in Section 4.2.6 and from the Process Serial Message Queue function.
      The Send Serial data operation starts by checking the status of the serial port. If the port is closed, then an attempt to open it is made. If it still fails to open, then this function returns a fail condition.
      The appropriate flags are set in order to be able to track the response or reply from the SDC automation system (i.e. Wailing For Serial, Received ACK, Received NAK, and Timeout).
      The packet preparation task involves the addition of a header (LF) and a footer (CR) to allow the SDC automation system to identify the start and end of each packet.
      The packet is then sent to the serial port and the action is recorded in the History table.
      At this stage a response is expected. The Handle Serial Input task (Refer to Section 4.2.6.3) is responsible for receiving incoming serial data and subsequently updating the above mentioned flags (Received ACK, Received NAK, or Timeout).
      If a NAK is received, the same message is resent (unless the retry limit has been reached).
      If an ACK is received, then this function returns a success condition and clears the Waiting For Serial flag.
      If no response was received within the predetermined timeout period, then the same event is resent (unless the retry limit has been reached).
      If the Retry limit has been reached, then this function returns a fail condition.
      The diagram in FIG. 4S illustrates the operation of the Send Serial Data function.
   4.2.6.3. Handle Serial Input
      The Handle Serial Input function is triggered by the Send Serial Data function (Refer to Section 4.2.6.2), and whenever the serial port detects incoming data.
      The Handle Serial Input function remains in a loop until no more data is available from the Serial Buffer. The arrival of any new data will re-trigger this function.
      Data read from the serial port is appended to a buffer until a valid (or recognized) terminating character is received. Valid terminating characters can be an ACK, a NAK or a CR.
      If an ACK is received, then the ReceivedACK flag is set and the ReceivedNAK flag is unset. This flag is used by the send Serial Data function described in Section 4.2.6.2.
      If a NAK is received, then the ReceivedNAK flag is set and the ReceivedACK flag is unset. This flag is used by the Send Serial Data function described in Section 4.2.6.2.
      If a CR is received (indicates a multi-character packet), then a check is made to see if the packet is a Heartbeat Request. If the Heartbeat was requested, then a Heartbeat Message is sent to the SDC automation system. However, if the system is currently waiting for a serial reply, then the Heartbeat Request is noted (and will be sent upon receipt of the expected reply as illustrated in FIG. 46).
      The diagram in FIG. 49 illustrates the operation of the Handle Serial Input function.

As can be seen from the above, a CLF which provides a redundant data path for back- to-base monitored alarm panels allows a CMS to effectively relocate and have the data path (e.g., alarm traffic) automatically follow. Actual or potential benefits of such a system include:
protection of the CMS against lost telephone lines and other data transfer means to its premises;
the CMS not requiring a dialer receiver to monitor dialer panels;
the CMS able to have one or more back-up locations to fall back on in the event that the primary location becomes unusable; and
enabling there to be a round-the-clock manned data centre as a last resort to monitor alarm events in the case where the other CMS fall back options fail.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-70. (canceled)

71. A redundant data path system for transmitting an alarm signal between a monitored facility and a destination facility, said system comprising:
alarm signal receiving means adapted to receive the alarm signal;
destination facility identifying means adapted to identify the destination facility to which the alarm signal was directed by the monitored facility;
destination facility monitoring means adapted to determine, at regular intervals, whether the destination facility is able to receive an alarm signal, either directly from the monitored facility or at all; and
alarm signal transmission means adapted to selectively transmit the alarm signal either to the identified destination facility, when said monitoring means indicates that the destination facility is not able to receive said alarm signal directly from the monitored facility, or to an alternate destination facility, when said monitoring means indicates that the destination facility is not able to receive said alarm signal at all.

72. The redundant data path system of claim 71, wherein the alarm signal receiving means is a private automatic branch exchange in communication with the monitored facility.

73. The redundant data path system of claim 71, wherein the alarm signal transmitted to the destination facility identifying means comprises monitored facility-specific data including at least one monitored facility parameter.

74. The redundant data path system of claim 73, wherein the destination facility identifying means includes a receiver farm, said receiver farm comprising at least one receiver means, and being adapted to generate a first identification parameter associated with the alarm signal.

75. The redundant data path system of claim 74, wherein the destination facility identifying means further includes a receiver farm server, said receiver farm server comprising at least one data connection means for each receiver means in the receiver farm, with each data connection means associated with a second identification parameter for the alarm signal, the receiver farm server adapted to use the first and second identification parameters to determine the destination facility for the alarm signal.

76. The redundant data path system of claim 73, wherein the monitored facility parameter comprises caller line identification data generated by the alarm signal receiving means.

77. The redundant data path system of claim 76, wherein the monitored facility-specific data is a pseudo extension number related to the caller line identification data.

78. The redundant data path system of claim 75, wherein the first identification parameter is a physical receiver number.

79. The redundant data path system of claim 75, wherein the second identification parameter is a number designated to the data connection means which receives the alarm signal.

80. The redundant data path system of claim 75, wherein the determination of the destination facility includes inputting the first and second identification parameters into a first database containing a plurality of parameters associating each monitored facility with at least one destination facility.

81. The redundant data path system of claim 80, wherein the determination of the destination facility further includes determining a destination bureau identification by reference to the first identification parameter and the second identification parameter.

82. The redundant data path system of claim 81, wherein the plurality of parameters associating each monitored facility with at least one destination facility includes the first identification parameter, the second identification parameter, a destination virtual receiver number, the destination bureau identification, and a destination line number.

83. The redundant data path system of claim 71, adapted to operate whether or not the alarm signal can be transmitted to the destination facility via a pre-existing data path system.

84. The redundant data path system of claim 75, wherein the alarm signal transmission means includes routing means adapted to transmit the alarm signal between the receiver farm server and the destination facility.

85. The redundant data path of claim 84, wherein the routing means comprises a routing means server and a routing means receiver, said routing means server being adapted to communicate with the routing means receiver to transmit the alarm signal to the destination facility.

86. The redundant data path system of claim 85, wherein transmission of the alarm signal between the receiver farm server and the destination facility includes manipulation of data associated with the alarm signal such that the data received by the destination facility appears substantially identical to that which would have been received by the destination facility if the alarm signal had been transmitted by a pre-existing data path system.

87. The redundant data path system of claim 86, wherein the routing means server communicates with the routing means receiver by one or more routing data path systems selected from the group consisting of asymmetric digital subscriber line means, satellite communication means, general packet radio service means, fixed line transmission means, wireless transmission means, and a data centre adapted to selectively transmit data from the routing means server to the routing means receiver or monitor transmission of the alarm signal without further transmitting the alarm signal to the destination facility.

88. The redundant data path system of claim 87, wherein the routing data path system is selected according to the availability or operability of each alternative routing data path system.

89. The redundant data path system of claim 88, wherein the data centre adopts the monitoring functions of one or more destination facilities when each of the alternative routing data path systems are disconnected or inoperable.

90. The redundant data path system of claim 87, wherein the destination facility selectively delegates its monitoring functions to the data centre by temporarily disconnecting each alternative routing data path system and each pre-existing data path system.
